(19) United States
(12) Patent Application Publication
(10) Pub. No.: US 2009/0258803 A1
(43) Pub. Date: Oct. 15, 2009

(54) COPOLYMERS MADE WITH QUASI-LIVING POLYOLEFINS AND UNSATURATED ACIDIC REAGENTS, DISPERSANTS USING SAME, AND METHODS OF MAKING SAME

(76) Inventor: James J. Harrison, Novato, CA (US)

Correspondence Address: JONES DAY, 222 EAST 41ST ST, NEW YORK, NY, 10017, US

(21) Appl. No.: 12/102,827

(22) Filed: Apr. 14, 2008

(51) Int. Cl. C08F 222/06; C08F 2/40; C08F 4/28; C10M 133/58

(52) U.S. Cl. 508/292; 526/271; 526/204; 526/217; 526/222; 526/212; 526/227

(57) ABSTRACT

Copolymers made with quasi-living polyolefins and unsaturated acidic reactants, dispersants using same, and methods of making same are provided. Under one aspect, a copolymer of an unsaturated acidic reactant and high molecular weight polyolefin, wherein the polyolefin comprises an exo-olefin terminated quasi-living polymeric product, is provided. The quasi-living polymeric product is formed, e.g., by forming a quasi-living cationic polyolefin under suitable quasi-living conditions, and contacting the cationic polyolefin with an agent selected to convert the cationic polyolefin to the exo-olefin terminated quasi-living polymeric product. The cationic polyolefin can be formed, e.g., by one of (a) contacting a cationically polymerizable monomer with an initiator, in the presence of a Lewis acid; (b) ionizing a tert-halide terminated polyolefin with a Lewis acid; (c) contacting a preformed polyolefin with a Lewis acid; or (d) contacting a cationically polymerizable monomer with an inifer carrying at least two tertiary halogens under cationic polymerization conditions.

### FIELD

The disclosed subject matter relates to copolymers made using polyolefins and unsaturated acidic reagents, dispersants using same, and methods of making same.

### BACKGROUND

Copolymers of polyolefins and unsaturated acidic reagents, and dispersants made from same, are useful components in lubricants, fuels, and other applications. For example, polyisobutylene (PIB) succinic anhydride (SA) copolymers, commonly referred to as “polyPIBSA,” are conventionally made by reacting PIB with maleic anhydride and a free radical initiator. Optionally, the polyPIBSA is then reacted with a polyamine to form polysuccinimides, or otherwise derivitized, for use in different compositions. For examples of methods of making polyPIBSA and uses of same, see, e.g., U.S. Pat. Nos. 5,112,507, 5,175,225, 5,616,668, 6,451,920, and 6,906,011, the entire contents of each of which are hereby incorporated herein by reference.

However, polyPIBSA and dispersants made from polyPIBSA using conventional methods do not necessarily have appropriate properties to be useful in a variety of climates. For example, conventional polyPIBSA, and/or dispersants made from same, may have a Cold Cranking Simulator (CCS) viscosity and/or kinematic viscosity (kv) that is not appropriate for all viscosity grades to enable the use of that polyPIBSA in lubricants intended for harsh winter climates.

Thus, there is a need for copolymers such as polyPIBSA, and dispersants made from same, having appropriate properties for use in compositions in a variety of climates, e.g., at temperatures below 0° C.

### SUMMARY

Provided herein are copolymers made by copolymerizing a quasi-living polyolefin with an unsaturated acidic reagent, dispersants made using such copolymers, and methods of making same.

Under one aspect, a copolymer of an unsaturated acidic reactant and a high molecular weight polyolefin, wherein the polyolefin comprises an exo-olefin terminated quasi-living polyolefin, is provided.

In some embodiments, the exo-olefin terminated quasi-living polyolefin is produced by first forming a quasi-living cationic polyolefin under suitable quasi-living conditions, and subsequently contacting the quasi-living cationic polyolefin with a quenching agent selected to convert the quasi-living cationic polyolefin to the exo-olefin terminated quasi-living polyolefin. The quenching agent can be, for example, at least one of a substituted pyrrole, a substituted imidazole, a hindered secondary amine, a hindered tertiary amine, and a dihydrocarbylmonosulfide.

In some embodiments, the quasi-living cationic polyolefin may be prepared by: (a) contacting at least one cationically polymerizable monomer (such as isobutylene) with an initiator, in the presence of a Lewis acid and diluent under suitable quasi-living conditions or by (b) ionizing a tert-halide terminated polyolefin with a Lewis acid. The copolymer of the present invention can be formed by contacting the exo-olefin terminated polyolefin with the unsaturated acidic reactant in the presence of a free radical initiator, such as a peroxide.

In some embodiments, the exo-olefin terminated polyolefin has a number average molecular weight between about 500 and about 10,000, e.g., between about 900 and about 5000, e.g., between about 900 and about 2500, or, e.g., between about 2000 and about 4000. In some embodiments, the exo-olefin terminated polyolefin has an exo-olefin end-group content of at least about 90%, or at least about 91%, or at least about 92%, or at least about 93%, or at least about 94%, or at least about 95%, or at least about 96%, or at least about 97%, or at least about 98%, or at least about 99%, or about 100%. In some embodiments, the polyolefin has a dispersion index (DI) of less than about 1.4, or less than about 1.3, or less than about 1.2, or less than about 1.1, or about 1.0.

The unsaturated acidic reactant can be of the formula:

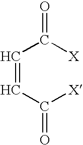

wherein X and X′ are each independently selected from the group consisting of —OH, —Cl, —O— lower alkyl, and when taken together, X and X′ are —O—. For example, the acidic reactant can include maleic anhydride.

In some embodiments, the copolymer has the formula:

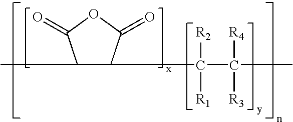

wherein n is 1 or greater; wherein either: R₁ and R₂ are hydrogen and one of R₃ and R₄ is lower alkyl and the other is high molecular weight polyalkyl, or R₃ and R₄ are hydrogen and one of R₁ and R₂ is lower alkyl and the other is high molecular weight polyalkyl; wherein the ratio of x:y is less than 3:1, wherein x is at least 1 (e.g., between 1 and 3), wherein y is at least 1 (e.g., between 1 and 3), and wherein n is greater than or equal to 1 (e.g., between 1 and 20, or between 1 and 10, or between 1 and 5, or between 1 and 3, or 2 or greater). The high molecular weight polyalkyl can include a polyisobutyl group having at least 30 carbon atoms, or at least 50 carbon atoms. The lower alkyl can be a methyl.

Under another aspect, a polysuccinimide prepared by reacting (1) a copolymer of an unsaturated acidic reactant and a high molecular weight polyolefin, wherein the polyolefin comprises an exo-olefin terminated quasi-living polymeric product, with (2) an amine, a polyamine having at least two basic nitrogens, or mixtures thereof, is provided.

Under another aspect, a lubricating oil composition comprising a major amount of an oil of lubricating viscosity and a minor amount of the above-mentioned polysuccinimide is provided.

Under another aspect, a method of making a copolymer comprises forming a quasi-living, high molecular weight, exo-olefin terminated polyolefin; and contacting the polyolefin with an unsaturated acidic reactant in the presence of a free radical initiator (such as a peroxide) to form a copolymer.

### DETAILED DESCRIPTION

Unless defined otherwise, all technical and scientific terms used herein have the same meaning as is commonly understood by one of ordinary skill in the art. In the event that there are a plurality of definitions for a term used herein, the definitions provided in this section prevail unless stated otherwise.

As used herein, “alcohol” refers to a compound of formula:

R—OH

wherein R is hydrocarbyl.

As used herein, “alkyl” refers to a carbon chain or group containing from 1 to 20 carbons, or 1 to 16 carbons. Such chains or groups may be straight or branched. Exemplary alkyl groups herein include, but are not limited to, methyl, ethyl, propyl, isopropyl, isobutyl, n-butyl, sec-butyl, tert-butyl, iospentyl, neopentyl, tert-pentyl, or isohexyl. As used herein, “lower alkyl” refers to carbon chains or groups having from 1 carbon atom to about 6 carbon atoms.

As used herein, “alkenyl” refers to a carbon chain or group containing from 2 to 20 carbons, or 2 to 16 carbons, wherein the chain contains one or more double bonds. An example includes, but is not limited to, an allyl group. The double bond of an alkenyl carbon chain or group may be conjugated to another unsaturated group. An alkenyl carbon chain or group may be substituted with one or more heteroatoms. An alkenyl carbon chain or group may contain one or more triple bonds.

As used herein, “alkynyl” refers to a carbon chain or group containing from 2 to 20 carbons, or 2 to 16 carbons, wherein the chain contains one or more triple bonds. An example includes, but is not limited to, a propargyl group. The triple bond of an alkynyl carbon chain or group may be conjugated to another unsaturated group. An alkynyl carbon chain or group may be substituted with one or more heteroatoms. An alkynyl carbon chain or group may contain one or more double bonds.

As used herein, “aryl” refers to a monocyclic or multicyclic aromatic group containing from about 6 to about 30 carbon atoms. Aryl groups include, but are not limited to, fluorenyl, phenyl, or naphthyl.

As used herein, “alkaryl” refers to an aryl group substituted with at least one alkyl, alkenyl, or alkynyl group.

As used herein, “aralkyl” refers to an alkyl, alkenyl, or alkynyl group substituted with at least one aryl group.

As used herein, “aromatic or aliphatic fused ring” refers to the ring formed by two adjacent carbon atoms on a pyrrole or imidazole ring, and the ring thus formed is fused to the pyrrole or imidazole ring. An example of a fused aromatic ring is a benzo group fused to a pyrrole ring or imidazole ring. A fused aliphatic ring may be any cyclic ring structure fused to a pyrrole ring or imidazole ring.

As used herein, “amide” refers to a compound of formula:

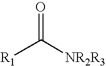

wherein R₁-R₃ are each, independently, hydrogen or hydrocarbyl.

As used herein, “amine” refers to a compound of formula:

R₃—NR₁R₂

wherein R₁-R₃ are each independently, hydrogen or hydrocarbyl.

As used herein, “carbocation” and “carbenium ion” refer to a positively charged carbon atom.

As used herein, “carbocation terminated polyolefin” refers to a polyolefin containing at least one carbocation end group. Examples include, but are not limited to, compounds of the formula:

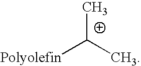

As used herein, “chain end concentration” refers to the sum of the concentrations of olefin end groups, tert-halide end groups, and carbenium ions. When a mono-functional initiator is used, the chain end concentration is approximately equal to the initiator concentration. For a multi-functional initiator, when the functionality of the initiator equals x, then the chain end concentration is approximately equal to x times the initiator concentration.

As used herein, “chain transfer agent” refers to a compound which interchanges its halide ion with a carbenium ion to form a new carbenium ion.

As used herein, “common ion salt” refers to an ionic salt that is optionally added to a reaction performed under quasi-living carbocationic polymerization conditions to prevent dissociation of the propagating carbenium ion and counter-ion pairs.

As used herein, “common ion salt precursor” refers to an ionic salt that is optionally added to a reaction performed under quasi-living carbocationic polymerization conditions, which generates counter-anions that are identical to those of the propagating chain ends, via in situ reaction with a Lewis acid.

As used herein, “coupled polyolefin” refers to the product of the addition of a carbocation terminated polyolefin to another polyolefin.

As used herein, “diluent” refers to a liquid diluting agent or compound. Diluents may be a single or a mixture of two or more compounds. Diluents may completely dissolve or partially dissolve the reaction components. Examples include, but are not limited to, hexane or methyl chloride, or mixtures thereof.

As used herein, “dihydrocarbylmonosulfide” refers to a compound of the formula:

R₁—S—R₂

wherein R₁ and R₂ are each, independently, hydrocarbyl.

As used herein, “electron donor” refers to a molecule that is capable of donating a pair of electrons to another molecule. Examples include, but are not limited to, molecules capable of complexing with Lewis acids. Further examples include, but are not limited to, bases and/or nucleophiles. Further examples include, but are not limited to, molecules capable of abstracting or removing a proton.

As used herein, “exo-olefin” refers to a compound of the formula

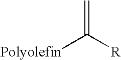

wherein R is hydrocarbyl, e.g., methyl or ethyl.

As used herein, “exo-olefin end group” or “exo-olefinic end group” refers to a terminal olefin moiety.

As used herein, “halide, “halo,” or “halogen” refer to F, Cl, Br, or I.

As used herein “hydrocarbyl” refers to a monovalent, linear, branched or cyclic group which contains only carbon and hydrogen atoms.

As used herein, “inifer” refers to a compound that acts as both an initiator and a chain transfer agent.

As used herein, “initiator” refers to a compound that provides a carbocation. Examples include, but are not limited to, compounds or polyolefins with one or more tertiary end groups. An initiator may be mono-functional or multi-functional. As used herein, “mono-functional initiator” refers to an initiator that provides approximately one stoichiometric equivalent of carbocation relative to initiator. As used herein, “multi-functional initiator” refers to an initiator that provides approximately x stoichiometric equivalents of carbocation relative to initiator, wherein x represents the functionality of the initiator. When a mono-functional initiator is used, the chain end concentration is approximately equal to the initiator concentration. For a multi-functional initiator, when the functionality of the initiator equals x, then the chain end concentration equals x times the initiator concentration.

As used herein, “ionized polyolefin” refers to a polyolefin containing at least one carbenium ion.

As used herein, “Lewis acid” refers to a chemical entity that is capable of accepting a pair of electrons.

As used herein, “monomer” refers to an olefin that is capable of combining with a carbocation to form another carbocation.

As used herein, “nitroalkane” refers to RNO₂, wherein R is alkyl, alkenyl, alkynyl, aryl, alkaryl, or aralkyl.

As used herein, “nitrogen-containing five-membered aromatic ring” refers to pyrroles and imidazoles containing between one and two nitrogen atoms in an aromatic ring, and having from about two to four alkyl groups containing from about 1 carbon atom to about 20 carbon atoms attached to the ring. One examples of a nitrogen-containing five-membered aromatic ring compound is a substituted pyrrole.

As used herein, “percent by mole of all products” refers to the proportion of the number of moles of a particular product of a reaction to the number of moles of all products of the reaction multiplied by one hundred.

As used herein, “dispersion index” or DI refers to the ratio of the weight average molecular weight of a polymer to the number average molecular weight of the polymer, and is reflective of the distribution of molecular masses in a polymer. A dispersion index of 1 indicates that the polymer is monodisperse. A dispersion index of greater than 1 indicates that there is a distribution of molecular masses of polymer chains in the polymer.

As used herein, “proton acceptor” refers to a compound capable of abstracting a proton.

As used herein, “pyridine derivative” refers to a compound of the formula:

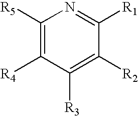

wherein R₁, R₂, R₃, R₄, and R₅ are each, independently, hydrogen or hydrocarbyl; or R₁ and R₂, or R₂ and R₃, or R₃ and R₄, or R₄ and R₅ independently form a fused aliphatic ring of about 4 to about 7 carbon atoms or a fused aromatic ring of about 5 to about 7 carbon atoms.

As used herein, “quasi-living carbocationic polymerization conditions” refers to quasi-living polymerization conditions that allow for the formation of quasi-living carbocationic polyolefins.

As used herein, “quasi-living carbocationic polyolefin” refers to a carbocationic polyolefin that has been formed under quasi-living polymerization conditions.

As used herein, “quasi-living polymerization” refers to polymerizations that proceed in the absence of irreversible chain-breaking events. Quasi-living polymerizations proceed by initiation and is followed by propagation, wherein propagating (living) species are in equilibrium with non-propagating (non-living) polymer chains.

As used herein, “quasi-living polymerization conditions” refers to reaction conditions that allow quasi-living polymerization to occur.

As used herein, “quenching” refers to reacting a carbenium ion with a quenching agent.

As used herein, “quenching agent” refers to a compound that can, either alone or in combination with another compound, react with a carbenium ion.

As used herein, “termination” refers to the chemical reaction that terminates a polymerization process or a quenching reaction by destruction of a Lewis acid.

As used herein, “terminator” refers to a chemical compound that terminates a polymerization process or a quenching reaction, but may not simultaneously initiate a new polymer chain.

As used herein, “tert-halide terminated polyolefin” refers to a polyolefin that contains at least one tertiary halide end group. An example includes, but is not limited to, a compound of formula:

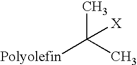

wherein X is a halogen.

Unless otherwise specified, all percentages are in weight percent.

This application is related to the following applications, the entire contents of each of which are incorporated by reference herein:

U.S. patent application Ser. No. 11/207,366, filed Aug. 19, 2005 and entitled “Method for Preparation of Polyolefins Containing Exo-Olefin Chain Ends;”

U.S. patent application Ser. No. 11/207,377, filed Aug. 19, 2005 and entitled “Method for Preparation of Polyolefins Containing Exo-Olefin Chain Ends;”

U.S. patent application Ser. No. 11/207,264, filed Aug. 19, 2005 and entitled “Method for Preparing Polyolefins Containing a High Percentage of Exo-Olefin Chain Ends;” and

U.S. patent application Ser. No. 12/055,281, filed Mar. 25, 2008 and entitled “Production of Vinylidene-Terminated Polyolefins Via Quenching with Monosulfides.”

Methods

In some embodiments, methods of forming copolymers such as those described herein include the steps of (1) providing a high molecular weight polyolefin, which is a quasi-living polymeric product, and (2) reacting the polyolefin with an unsaturated acidic reagent in the presence of an initiator, to form the copolymer.

In some embodiments, the polyolefin is a quasi-living polyolefin having exo-olefinic chain ends, the initiator is a peroxide, and the unsaturated acidic reagent is maleic anhydride. In such embodiments, the resulting copolymer is of the formula:

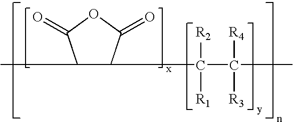

wherein n is 1 or greater; wherein either:

a. R₁ and R₂ are hydrogen and one of R₃ and R₄ is lower alkyl and the other is high molecular weight polyalkyl, or

b. R₃ and R₄ are hydrogen and one of R₁ and R₂ is lower alkyl and the other is high molecular weight polyalkyl. In some embodiments, the ratio of x:y is less than 3:1, wherein x is at least 1 (e.g., between 1 and 3), wherein y is at least 1 (e.g., between 1 and 3), and wherein n is greater than 1 (e.g., between 1 and 20, or between 1 and 10, or between 1 and 5, or between 1 and 3, or 2 or greater). In some embodiments, R₁ and R₂ are hydrogen, R₃ is methyl, and R₄ is a high molecular weight polyisobutylene chain.

For example, in some embodiments of methods forming polyPIBSA, the polyolefin is quasi-living PIB of the formula:

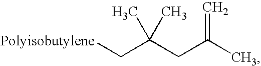

and has a relatively high percent of exo-olefinic end groups, e.g., greater than 90%, or greater than 91%, or greater than 92%, or greater than 93%, or greater than 94%, or greater than 95%, or greater than 96%, or greater than 97%, or greater than 98%, or greater than 99%, or even 100% exo-olefinic end groups. The quasi-living PIB also has a relatively low DI, e.g., between about 1.4 and 1.0, or between about 1.3 and 1.0, or between about 1.2 and 1.0, or between about 1.1 and 1.0, or about 1.0. The quasi-living PIB is contacted with the free radical initiator, e.g., a peroxide such as di-tert-amyl peroxide, and with the unsaturated acidic reactant maleic anhydride.

Whereas conventional methods of making polyPIBSA typically involve reacting commercially purchased or otherwise conventional PIB with maleic anhydride and a free radical initiator, the use of quasi-living PIB provides multiple benefits, relative to that possible using conventional PIB. By “conventional PIB” it is meant PIB that has a relatively low percent of exo-olefin end groups, e.g., less than about 80%, and has a high dispersion index (DI), e.g., greater than 1.4. Such conventional PIB is sometimes referred to as “high methylvinylidene PIB,” or “highly reactive PIB.”

Among other things, the use of quasi-living PIB in the formation of polyPIBSA provides a polymeric product having an improved yield, e.g., greater than 80%, or greater than 85%, or greater than 90%, or greater than 91%, or greater than 92%, or greater than 93%, or greater than 94%, or greater than 95%, or greater than 96%, or greater than 97%, or greater than 98%, or greater than 99%, or even 100% yield. In contrast, polyPIBSA formed using conventional PIB typically has a relatively low yield, e.g., below about 60-80%. Additionally, the use of quasi-living PIB in the formation of polyPIBSA provides a polymeric product having a relatively low DI, e.g., between about 1.4 and 1.0, or between about 1.3 and 1.0, or between about 1.2 and 1.0, or between about 1.1 and 1.0. In contrast, polyPIBSA formed using conventional PIB typically has a relatively high DI, e.g., greater than about 1.4. Improved yield of polyPIBSA is useful because it means that there is a smaller amount of unreacted PIB in the product. This is advantageous because the unreacted PIB is an expensive diluent and larger amounts of unreacted PIB in the polyPIBSA increase the overall cost of the product. Also, the presence of less unreacted PIB can be useful because PIB can have less useful viscosity properties resulting in less useful low temperature performance. A DI of between about 1.4 and 1.0 for the quasi-living PIB used to make the polyPIBSA is useful because, without wishing to be bound by theory, it is believed that a lower DI will result in improved low temperature performance for the polyPIBSA and the polysuccinimides made from quasi-living PIB.

In addition to improved yield and lower dispersion index, polyPIBSA formed using quasi-living PIB, and derivatives thereof, also exhibits improved viscosity properties. Multigrade oils (for example a 10W30 oil) meet the SAE 10W viscosity limit at low temperatures and the SAE 30 viscosity limit at high temperatures. Ways to meet the desired viscosity targets include using: 1) blends of different viscosity base oils (for example 100 neutral plus 600 neutral oils); 2) unconventional base oils with high viscosity index (VI); 3) a detergent/inhibitor additive package with a lower Cold Crank Simulator (CCS) thickening; and 4) viscosity index improvers (VI improvers) which improve the viscosity index of formulated oils. The use of the right combination of these four variables can produce formulated oils with high kinematic viscosity (kv) at 100° C. and low CCS viscosity at, for example, −20° C.

The use of polyPIBSA and polysuccinimides made from quasi-living PIB are examples of meeting the desired viscosity targets using a detergent/inhibitor additive package with improved CCS and kv performance as disclosed in 3) above. Under certain conditions, e.g., for a high fuel economy passenger car motor oil (PCMO) formulation it may be desirable for a dispersant to have both a low CCS viscosity and a low kv This can be determined by measuring the CCS and the kv for a dispersant dissolved in a diluent oil. A dispersant with a lower CCS and kv may have the best performance.

Under other conditions, it is sometimes useful for the dispersant to have a high kv and a low CCS viscosity so that less VI improver is needed to meet the desired viscosity grade. This can be determined by plotting the CCS versus kv and measuring the slope. The dispersant with the lowest slope has improved performance.

For example, as illustrated in greater detail in the “Examples” section below, our results show that for both polyPIBSA from ˜1000 MW PIB and polyPIBSA from ˜2300 MW PIB the CCS viscosity and kv were lower for the polyPIBSA derived from quasi-living PIB compared to the polyPIBSA derived from the non-quasi-living PIB. Without wishing to be bound by theory, it is believed that this may be due to the fact that the quasi-living PIB that was used to make the polyPIBSAs in Examples 1 and 3 had a lower dispersion index (DI=1.05-1.11) than the non-quasi-living PIB (DI=1.71-1.89) that was used to make the polyPIBSAs in Examples 2 and 4. This indicates that polyPIBSA made from quasi-living PIB would be expected to give better performance than polyPIBSA made from non-quasi-living PIB in an oil where a high fuel economy PCMO formulation is desired.

As shown in Table 2 below, the slope of the CCS versus kv plot for the polyPIBSA made from the quasi-living PIB (˜1000 MW) was lower than the slope for the polyPIBSA made from the non-quasi-living PIB (˜1000 MW). This means that polyPIBSA made from quasi-living PIB (˜1000 MW) would be expected to perform better than polyPIBSA made from non-quasi-living PIB (˜1000 MW) in an oil where less VI improver is needed to meet the desired viscosity grade.

In addition, as illustrated in greater detail in the “Examples” section below, results show that both the CCS viscosity and the kv for the polysuccinimide made from the 2300 molecular weight quasi-living PIB were lower than the CCS viscosity and the kv for the polysuccinimide made from the 2300 molecular weight non-quasi-living PIB. This indicates that polyPIBSA made from the 2300 molecular weight quasi-living PIB would be expected to give better performance than polyPIBSA made from the 2300 molecular weight non-quasi-living PIB in an oil where a high fuel economy PCMO formulation is desired. This was not the case for the polysuccinimide made from the 1000 molecular weight quasi-living PIB. In this case the CCS viscosity was about the same as the CCS viscosity for the polysuccinimide made from the 1000 molecular weight non-quasi-living PIB. Moreover, the kv for the polysuccinimide made from the 1000 molecular weight quasi-living PIB was greater than the kv for the polysuccinimide made from the 1000 molecular weight non-quasi-living PIB. This indicates that polyPIBSA made from the 1000 molecular weight quasi-living PIB may not give better performance than polyPIBSA made from the 1000 molecular weight non-quasi-living PIB where a high fuel economy PCMO formulation is desired.

As shown in Table 4 below, the slope of the CCS versus kv plot for the polysuccinimide made from the 1000 molecular weight quasi-living PIB (slope=186) was lower than the slope for the polysuccinimide made from the 1000 molecular weight non-quasi-living PIB (slope=271). This means that the polysuccinimide made from the 1000 molecular weight quasi-living PIB would be expected to perform better than the polysuccinimide made from the 1000 molecular weight non-quasi-living PIB in an oil where less VI improver is needed to meet the desired viscosity grade. This was not true for the polysuccinimide made from the 2300 molecular weight quasi-living PIB in an oil where less VI improver is needed to meet the desired viscosity grade.

Various embodiments of different reactants and diluents that can be used to form copolymers made with quasi-living olefins and unsaturated acidic reactants, and useful ranges of reaction conditions for the formation of such copolymers, will now be described in greater detail. Then, some exemplary methods of preparing dispersants using such copolymers will be described, and several illustrative examples provided.

(I) Quasi-Living, Exo-Olefin Terminated Polyolefins

Quasi-living olefins terminated with exo-olefin groups, such as quasi-living PIB with a an exo-olefin end group, can be prepared using a variety of suitable methods. Some exemplary methods are described further below.

In some embodiments, the quasi-living polyolefin can be a polymer of a single type of olefin or it can be a copolymer of two or more types of olefins, so long as the olefin has a relatively high percentage of exo-olefinic end groups (e.g., greater than about 90%, or greater than about 91%, or greater than about 92%, or greater than about 93%, or greater than about 94,%, or greater than about 95%, or greater than about 96%, or greater than about 97%, or greater than about 98%, or greater than about 99%, or greater than about 100%) and has a relatively low DI (e.g., between about 1.0 and 1.4, or about 1.0 and 1.3, or about 1.0 and 1.2, or about 1.0 and 1.1, or about 1).

In some embodiments, the quasi-living polyolefin has a “high molecular weight.” The term “high molecular weight polyolefin” refers to an polyolefin (including polyolefins having residual unsaturation) of sufficient molecular weight and chain length to lend solubility in lubricating oil to their reaction products. The term “soluble in lubricating oil” refers to the ability of a material to dissolve in aliphatic and aromatic hydrocarbons such as lubricating oils or fuels in essentially all proportions. Typically, polyolefins having about 30 carbons or greater, or 50 carbons or greater, are considered to have a “high molecular weight” and dissolve in lubricating oils and fuels.

In some embodiments, the quasi-living polyolefin has a number average molecular weight (Me) from about 500 to about 10000, or from about 900 to about 5000, or from about 900 to about 2500, or from about 2000 to about 4000.

(A) Quasi-living, Exo-Olefin Terminated Polyolefins Formed By Quenching Ionized Polyolefins

In some embodiments, the quasi-living polyolefin is an exo-olefin terminated polyolefin formed by quenching an ionized polyolefin, having, e.g., one, two, three, or more cationic end groups, to form an exo-olefinic end group. In some embodiments, the ionized polyolefin is a polyisobutylene with a cationic end group, e.g., having following formula:

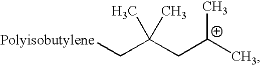

and the quasi-living polyolefin is an exo-olefin-terminated polyisobutylene, e.g., having the following formula:

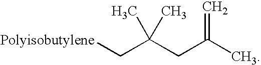

(1) Ionized Polyolefins

(a) Ionized Polyolefins from tert-halides

In some embodiments, the ionized polyolefin is derived from a tert-halide terminated polyolefin, such as a tert-chloride terminated polyolefin, tert-bromide terminated polyolefin, and/or tert-iodide terminated polyolefin. Specifically, in some embodiments, the tert-halide terminated polyolefin is contacted with a Lewis acid. The Lewis acid abstracts the tert-halide group from the polyolefin, forming a carbocationic polyolefin. Tert-halide terminated polyolefins may be made by any suitable method, e.g., based on inifer methods known in the art.

((b) Ionized Polyolefins from Preformed Polyolefins

In some embodiments, the ionized polyolefin is derived from a preformed polyolefin, e.g., a preformed polyolefin having one or more double bonds, some or substantially all of which are “endo,” or some or substantially all of which are “exo.” For example, pre-formed polyisobutylene, or a derivative thereof, can be used. The preformed polyolefin is contacted with a Lewis acid to generate the ionized polyolefin.

(c) Ionized Polyolefins Derived from Olefinic Monomers Under Quasi-Living Carbocationic Polymerization Conditions

In some embodiments, the ionized polyolefin is derived from olefinic monomers under quasi-living carbocationic conditions. Under such conditions, a quasi-living carbocationic polyolefin is generated. Such conditions may be achieved by any suitable method. Non-limiting examples of such methods are described in EP 206756 B1 and WO 2006/110647 A1, the entire contents of both of which are incorporated herein by reference.

In some embodiments, a monomer, an initiator, and a Lewis acid are used to form the quasi-living ionized polyolefin, e.g., a quasi-living carbocationic polyisobutylene, e.g., a compound of the following formula:

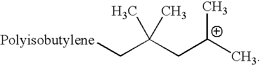

### (i) Initiators for Quasi-Living Carbocationic Polymerizations

In some embodiments, the initiator is a compound or polyolefin with one, or more than one, tertiary end groups. For example, the initiator can be a compound of formula (X′—CRₐR_{b})ₙR_{c} wherein Rₐ, R_{b} and R_{c} are, independently, at least one of alkyl, aromatic, alkyl aromatic groups, and can be the same or different, and X′ is an acetate, etherate, hydroxyl group, or a halogen. In some embodiments, R_{c} has a valence of n, and n is an integer of one to 4. In some embodiments, Rₐ, R_{b} and R_{c} are hydrocarbon groups containing one carbon atom to about 20 carbon atoms. In some embodiments, Rₐ, R_{b} and R_{c} are hydrocarbon groups containing one carbon atom to about 8 carbon atoms. In some embodiments, X′ is a halogen. In some embodiments, X′ is chloride. In some embodiments, the structure of Rₐ, R_{b} and R_{c} mimics the growing species or monomer. In some embodiments, such structure is a 1-phenylethyl derivative for polystyrene or a 2,4,4-trimethyl pentyl derivative for polyisobutylene. In some embodiments, the initiator is a cumyl, dicumyl or tricumyl halide. In some embodiments, chlorides are used.

Some exemplary initiators include 2-chloro-2-phenylpropane, i.e., cumyl chloride; 1,4-di(2-chloro-2-propyl)benzene, i.e., di(cumylchloride); 1,3,5-tri(2-chloro-2-propyl)benzene, i.e., tri(cumylchloride); 2,4,4-trimethyl-2-chloropentane; 2-acetyl-2-phenylpropane, i.e., cumyl acetate; 2-propionyl-2-phenyl propane, i.e., cumyl propionate; 2-methoxy-2-phenylpropane, i.e., cumylmethyl ether; 1,4-di(2-methoxy-2-propyl)benzene, i.e., di(cumylmethyl ether); 1,3,5-tri(2-methoxy-2-propyl)benzene, i.e., tri(cumylmethyl ether); 2-chloro-2,4,4-trimethyl pentane (TMPCl); 1,3-di(2-chloro-2-propyl)benzene; and 1,3,-di(2-chloro-2-propyl)-5-tert-butylbenzene (bDCC).

In some embodiments, the initiator can be mono-functional, bi-functional, or multi-functional. Some examples of mono-functional initators include 2-chloro-2-phenylpropane, 2-acetyl-2-phenylpropane, 2-propionyl-2-phenylpropane, 2-methoxy-2-phenylpropane, 2-ethoxy-2-phenylpropane, 2-chloro-2,4,4-trimethylpentane, 2-acetyl-2,4,4,-trimethylpentane, 2-propionyl-2,4,4-trimethylpentane, 2-methoxy-2,4,4-trimethylpentane, 2-ethoxy-2,4,4-trimethylpentane, and 2-chloro-2,4,4-trimethylpentane. Some examples of bi-functional initiators include 1,3-di(2-chloro-2-propyl)benzene, 1,3-di(2-methoxy-2-propyl)benzene, 1,4-di(2-chloro-2-propyl)benzene, 1,4-di(2-methoxy-2-propyl)benzene, and 5-tert-butyl-1,3,-di(2-chloro-2-propyl)benzene. Some examples of multi-functional initiators include 1,3,5-tri(2-chloro-2-propyl)benzene and 1,3,5-tri(2-methoxy-2-propyl)benzene.

### (ii) Monomers for Quasi-Living Polymerization Reactions

In some embodiments, the monomer is a hydrocarbon monomer, i.e., a compound containing only hydrogen and carbon atoms, including but not limited to, olefins and diolefins, and those having from about 2 to about 20 carbon atoms, e.g., from about 4 to about 8 carbon atoms. Some exemplary monomers include isobutylene, styrene, beta pinene, isoprene, butadiene, and substituted compounds of the preceding types, e.g., 2-methyl-1-butene, 3-methyl-1-butene, 4-methyl-1-pentene, or beta-pinene. Mixtures of monomers can also be used.

In some embodiments, the monomers are polymerized to produce polymers of different, but substantially uniform molecular weights. In some embodiments, the molecular weight of the polymer is from about 300 to in excess of a million g/mol. In some embodiments, such polymers are low molecular weight liquid or viscous polymers having a molecular weight of from about 200 to 10,000 g/mol, or solid waxy to plastic, or elastomeric materials having molecular weights of from about 100,000 to 1,000,000 g/mol, or more.

(d) Ionized Polyolefins from the Inifer Method

In some embodiments, the ionized polyolefin is derived from an inifer, e.g., using methods known to those of skill in the art. Non-limiting examples of such methods are described in U.S. Pat. Nos. 4,276,394 and 4,568,732, the entire contents of each of which is incorporated herein by reference. In some embodiments, a monomer is reacted with an inifer carrying at least two tertiary halogens under cationic polymerization conditions. In some embodiments, the inifer is a binifer or a trinifer. In some embodiments, the inifer is tricumyl chloride, paradicumyl chloride, or tricumyl bromide.

(e) Lewis Acids

In the methods provided herein, in some embodiments, the Lewis acid is a non-protic acid, e.g., a metal halide or non-metal halide.

Some examples of metal halide Lewis acids include a titanium (IV) halide, a zinc (II) halide, a tin (IV) halide, and an aluminum (III) halide, e.g., titanium tetrabromide, titanium tetrachloride, zinc chloride, AlBr₃, and alkyl aluminum halides such as ethyl aluminum dichloride and methyl aluminum bromide. Some examples of non-metal halide Lewis Acids include an antimony (VI) halide, a gallium (III) halide, or a boron (III) halide, e.g., boron trichloride, or a trialkyl aluminum compound such as trimethyl aluminum.

Mixtures of two, or more than two, Lewis acids can also used. In one example, a mixture of an aluminum (III) halide and a trialkyl aluminum compound is used. In some embodiments, the stoichiometric ratio of aluminum (III) halide to trialkyl aluminum is greater than 1, while in other embodiments, the stoichiometric ratio of aluminum (III) halide to trialkyl aluminum is less than 1. For example, a stoichiometric ratio of about 1:1 aluminum (III) halide to trialkyl aluminum compound; a stoichiometric ratio of 2:1 aluminum (III) halide to trialkyl aluminum compound; or a stoichiometric ratio of 1:2 aluminum (III) halide to trialkyl aluminum can be used. In another example, a mixture of aluminum tribromide and trimethyl aluminum is used.

In some embodiments, the Lewis acid can be added in a suitable number of aliquots, e.g., in one aliquot or more than one aliquot, e.g., two aliquots.

(f) Electron Donors

In some embodiments, an electron donor is used to convert a traditional polymerization system into a quasi-living polymerization and/or to enhance control over a quasi-living polymerization reaction. As is understood to one of ordinary skill in the art, some electron donors are capable of converting traditional polymerization systems into quasi-living polymerization systems and/or enhancing control over quasi-living polymerization reactions.

In some embodiments, the electron donor is capable of complexing with Lewis acids. In some embodiments, the electron donor is a base and/or nucleophile, e.g., an organic base. In some embodiments, the electron donor is capable of abstracting or removing a proton. Some exemplary electron donors include amides such as N,N-dimethylformamide, N,N-dimethylacetamide, and/or N,N-diethylacetamide; sulfoxides such as dimethyl sulfoxide; esters such as methyl acetate and/or ethyl acetate; phosphate compounds such as trimethyl phosphate, tributyl phosphate, and/or triamide hexamethylphosphate; and oxygen-containing metal compounds such as tetraisopropyl titanate.

In some embodiments, the electron donor is pyridine or a pyridine derivative, e.g., a compound of formula:

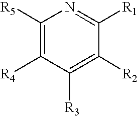

wherein R₁, R₂, R₃, R₄, and R₅ are each, independently, hydrogen or hydrocarbyl; or R₁ and R₂, or R₂ and R₃, or R₃ and R₄, or R₄ and R₅ independently form a fused aliphatic ring of about 3 to about 7 carbon atoms or a fused aromatic ring of about 5 to about 7 carbon atoms. In some embodiments, R₁ and R₅ are each, independently, hydrocarbyl, and R₂-R₄ are hydrogen. Some exemplary pyridine derivatives useful as electron donors include 2,6-di-tert-butylpyridine, 2,6-lutidine, 2,4-dimethylpryidine, 2,4,6-trimethylpyridine, 2-methylpyridine, and/or pyridine. Other exemplary electron donors include N,N-dimethylaniline and/or N,N-dimethyltoluidine.

(g) Common Ion Salts and Ion Salt Precursors

In the methods provided herein, in some embodiments, common ion salts or salt precursors may be optionally added to the reaction mixture in addition to or in replacement of the electron donor. In some embodiments, such salts may be used to increase the ionic strength, suppress free ions, and interact with ligand exchange. Tetra-n-butylammonium chloride and tetra-n-butylammonium iodide are examples of common ion salt precursors. In some embodiments, the concentration of the common ion salts or salt precursors in the total reaction mixture may be in the range from about 0.0005 moles per liter to about 0.05 moles per liter, e.g., from about 0.0005 moles per liter to about 0.025 moles per liter, e.g., from about 0.001 moles per liter to about 0.007 moles per liter.

(2) Agents for Generating Exo-Olefin Terminated Polyolefins from Ionized Polyolefins

After forming an ionized polyolefin having a carbocationic end group, the carbocationic end group can be converted to an exo-olefinic end group by reacting the ionized polyolefin with suitable reactants. Some examples of agents suitable for converting carbocationic end groups to exo-olefinic end groups are provided below; however it should be recognized that many other types of agents can be suitably used to provide polyolefins having exo-olefinic end groups.

(a) Nitrogen-Based Quenching Agents

In some embodiments, a nitrogen-based quenching agent, such as nitrogen-containing five-membered aromatic ring compound, e.g., a substituted pyrrole or substituted imidazole; a hindered secondary or tertiary amine; or a mixture of a nitrogen-containing five-membered aromatic ring and a hindered secondary or tertiary amine, is used as a quenching agent in the preparation of exo-olefinic polyolefins. Without being limited to any theory, the reaction may proceed by the following scheme:

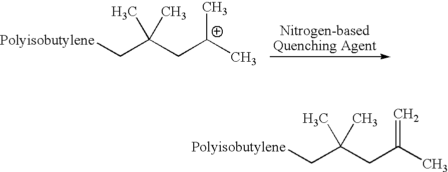

Without being limited to any theory, in some embodiments, the nitrogen-based quenching agent, e.g., substituted pyrrole or imidazole, complexes with a Lewis acid (such as a titanium halide counterion) and converts the cationic end group of the polyolefin to an exo-olefin end group. In some embodiments, this conversion regenerates the nitrogen-based quenching agent.

Some exemplary nitrogen-based quenching agents will now be described.

In some embodiments, the substituted pyrrole has the formula:

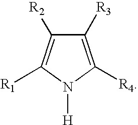

In some embodiments, R₁ and R₄ are, independently, alkyl; and R₂ and R₃ are, independently, hydrogen or alkyl, cycloalkyl, aryl, or alkaryl. In other embodiments, R₁ and R₂ form a fused aromatic ring of from about 6 to 10 carbon atoms, or an aliphatic ring of from about 4 to 8 carbon atoms, and R₄ is alkyl, cycloalkyl, aryl, alkaryl, or aralkyl. In other embodiments, R₂ and R₃ form a fused aromatic ring of from about 6 to 10 carbon atoms or an aliphatic ring of from about 4 to 8 carbon atoms, and R₁ and R₄ are, independently, alkyl. In still other embodiments, both R₁ and R₂, and R₃ and R₄, taken in pairs, independently form a fused aromatic ring of from about 6 to 10 carbon atoms or an aliphatic ring of from about 4 to 8 carbon atoms.

In some embodiments, the substituted imidazole has the formula:

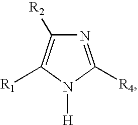

wherein R₃ is branched alkyl, and wherein either R₁ and R₂ are independently hydrogen, alkyl, cycloalkyl, aryl, alkaryl, or aralkyl; or R₁ and R₂ form a fused aromatic ring of from about 6 to 10 carbon atoms or an aliphatic ring of from 4 to 8 carbon atoms.

Some non-limiting examples of suitable nitrogen-containing five-membered aromatic ring compounds include 2,5-dimethylpyrrole, 2,3-dimethylindole, and carbazole.

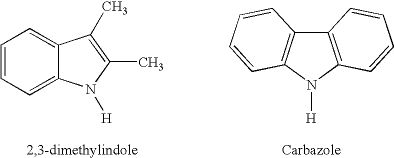

The nitrogen-containing five-membered aromatic ring compound is not one of the following compounds: 2,4-dimethylpyrrole; 1,2,5-trimethylpyrrole; 2-phenylindole; 2-methylbenzimidazole; 1,2-dimethylimidazole; 2-phenylimidazole; or 2,4,5-triphenylimidazole.

The hindered secondary or tertiary amine has the general formula:

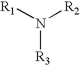

where R₁, R₂, and R₃ are, independently, hydrogen, and hydrocarbyl, e.g., alkyl, cycloalkyl, aryl, alkaryl, aralkyl, or at least one of the pair of R₁ and R₂, R₂ and R₃, or R₁ and R₃ independently forms a fused aliphatic ring of from about 4 to 8 carbon atoms.

In some embodiments, the hindered secondary or tertiary amine has the formula:

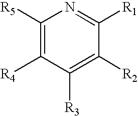

wherein one of R₁ and R₅ is hydrogen and the other is a branched alkyl of about 3 to 20 carbon atoms, aryl of about 10 to 30 carbon atoms, or aralkyl of about 11 to 30 carbon atoms; R₂, R₃, and R₄ are, independently, hydrogen, alkyl, cycloalkyl, aryl, alkaryl, aralkyl; or at least one of R₂ and R₂, R₂ and R₃, R₃ and R₄, and R₄ and R₅, taken in pairs, independently form a fused aromatic ring of from about 5 to 7 carbon atoms, or an aliphatic ring of from about 4 to 8 carbon atoms; provided that if R₁ and R₂ form a fused aliphatic or aromatic ring, then R₁ is a branched alkyl of about 3 to 20 carbon atoms, aryl of about 10 to 30 carbon atoms, or aralkyl of about 11 to 30 carbon atoms, and provided that if R₄ and R₅ form a fused aliphatic or aromatic ring, then R₁ is a branched alkyl of about 3 to 20 carbon atoms, aryl of about 10 to 30 carbon atoms, or aralkyl of about 11 to 30 carbon atoms.

Other heteroaromatic ring structures are possible. For example, the hindered secondary or tertiary amine can have the formula:

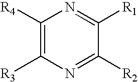

wherein one of R₁ and R₄ is hydrogen and the other is alkyl, cycloalkyl, aryl, aralkyl, or alkaryl, one of R₂ and R₃ is hydrogen and the other is alkyl, aryl, aralkyl, or alkaryl; or at least one of R₁ and R₂, and R₃ and R₄, taken in pairs, independently form a fused aromatic ring of from about 5 to 7 carbon atoms or aliphatic ring from about 4 to 8 carbon atoms.

Or, for example, the hindered secondary or tertiary amine can have the following formula:

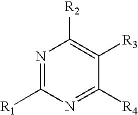

wherein R₁, R₂, R₃, and R₄ are, independently, hydrogen, alkyl, cycloalkyl, aryl, alkaryl, aralkyl; or wherein at least one of R₂ and R₃, or R₃ and R⁴, taken in pairs, independently form a fused aromatic ring of from about 5 to 7 carbon atoms, or an aliphatic ring of from about 4 to 8 carbon atoms; provided that if R₁ is hydrogen then R₂ and R₄ are independently alkyl, cycloalkyl, aryl, alkaryl, or aralkyl; and provided that if R₂ or R₄ is hydrogen, then R₁ is alkyl, cycloalkyl, aryl, alkaryl, or aralkyl.

Or, for example, the hindered secondary or tertiary amine can have the following formula:

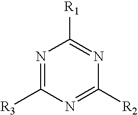

wherein R₁, R₂, and R₃ are independently hydrogen, alkyl, cycloalkyl, alkaryl, or aralkyl.

Some non-limiting examples of suitable hindered secondary or tertiary amines

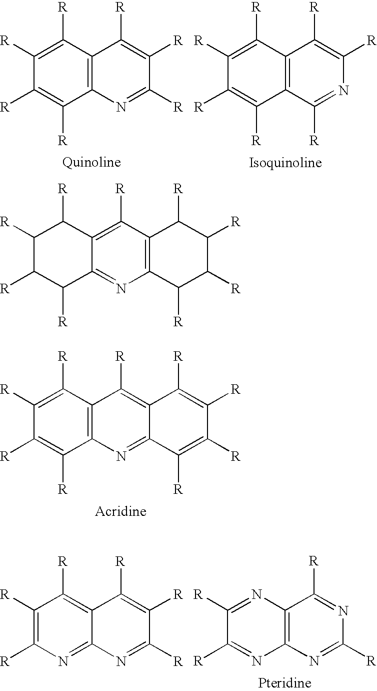

wherein R is, independently, hydrogen or hydrocarbyl.

The hindered secondary or tertiary amine is not one of the following compounds: triethylamine; tri-n-butylamine; trihexylamine; triisooctylamine; 2-phenylpyridine; 2,3-cyclododenopyridine; di-p-tolylamine; quinaldine; or 1-pyrrodino-1-cyclopentene.

For further details, see U.S. patent application Ser. No. 11/207,366, filed Aug. 19, 2005 and entitled “Method for Preparation of Polyolefins Containing Exo-Olefin Chain Ends,” the entire contents of which are incorporated by reference herein; U.S. patent application Ser. No. 11/207,377, filed Aug. 19, 2005 and entitled “Method for Preparation of Polyolefins Containing Exo-Olefin Chain Ends,” the entire contents of which are incorporated by reference herein; and U.S. patent application Ser. No. 11/207,264, filed Aug. 19, 2005 and entitled “Method for Preparing Polyolefins Containing a High Percentage of Exo-Olefin Chain Ends,” the entire contents of which are incorporated by reference herein.

(b) Monosulfide Agents and Proton Acceptors

In some embodiments, a monosulfide reagent, e.g., a dihydrocarbylmonosulfide reagent having the formula:

R₁—S—R₂

wherein R₁ and R₂ are each, independently, hydrocarbyl, is complexed with the ionized polyolefin. Then, a proton acceptor is introduced to generate a polyolefin with an exo-olefinic end group, and optionally to regenerate the monosulfide reagent.

In some embodiments, R₁ and R₂ are each, independently, alkyl, alkenyl, alkynyl, aryl, alkaryl, aralkyl, or cycloalkyl. In some embodiments, the dihydrocarbylmonosulfide is diethylsulfide, dipropylsulfide, diisopropylsulfide, diallylsulfide, diisoamylsulfide, di-sec-butyl sulfide, diisopentyl sulfide, dimethallylsulfide, methyl tert-octyl sulfide, dinonyl sulfide, dioctadecyl sulfide, dipentyl sulfide, di-tert-dodecyl sulfide, or diallylsulfide.

Without being limited to any theory, in some embodiments, the dihydrocarbylmonosulfide reacts with the ionized polyolefin to form a stable sulfonium ion terminated polyolefin. The sulfonium ion terminated polyolefin may be ion-paired with a Lewis acid derived counterion, e.g., a titanium halide such as ⁻Ti₂Cl₉. Reaction of the complex with a proton acceptor generates an exo-olefinic polyolefin, and regenerates the dihydrocarbylmonosulfide. Without being limited to any theory, in some embodiments, a proton acceptor abstracts a proton from the sulfonium ion terminated polyolefin. Without being limited to any theory, in some embodiments, the reaction between the dihydrocarbylmonosulfide, ionized polyolefin, and proton acceptor proceeds by the reaction pathway described in the following scheme:

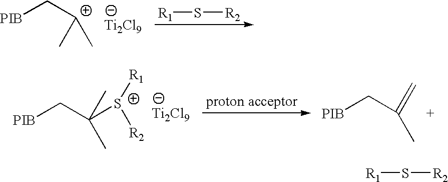

The proton acceptor can have either the same, or a different, formula than the electron donor described, supra. In some embodiments, the proton acceptor is an organic base, such as an amine having the formula:

R₃—NR₁R₂

wherein R₁, R₂, and R₃ are each, independently, hydrogen or hydrocarbyl, e.g., alkyl, alkenyl, alkynyl, cycloalkyl, alkaryl, aralkyl, or aryl. In some embodiments, R₁ and R₂, together, form a ring of from about 3 to about 7 carbon atoms. In some embodiments, the proton acceptor has more than one —NR₁R₂ group. In some embodiments, the proton acceptor is a primary, secondary, or tertiary amine. Some examples of suitable amines include dimethyl amine, diethyl amine, dipropyl amine, n-butyl amine, tert-butyl amine, sec-butyl amine, di-n-butylamine, aniline, cyclohexylamine, cyclopentyl amine, tert-amylamine, trimethyl amine, triethylamine, tripropyl amine, and tributylamine.

In some embodiments, the proton acceptor is an alcohol having the formula:

R—OH

wherein R is hydrocarbyl, e.g., R is alkyl, alkenyl, alkynyl, alkaryl, aralkyl, or aryl. In some embodiments, the —OH is attached to a primary, secondary, or tertiary carbon. In some embodiments. In some embodiments, the proton acceptor has more than one —OH group. Examples of suitable alcohols include methanol, ethanol, 1-propanol, isopropanol, 1-butanol, 2-butanol, tert-butanol, cyclohexanol, cyclopentanol, and phenol.

For further details, see U.S. patent application Ser. No. 12/055,281, filed Mar. 25, 2008 and entitled “Production of Vinylidene-Terminated Polyolefins Via Quenching with Monosulfides,” the entire contents of which are incorporated by reference herein.

(B) Quasi-Living, Exo-Olefin Terminated Polyolefins Formed with Potassium tert-Butoxide

Quasi-living, exo-olefin terminated polyolefins can alternatively be formed by reacting a tert-halide terminated polyolefin (see above) with potassium tert-butoxide (t-BuOK). Briefly, in one embodiment, the tert-halide terminated polyolefin (e.g., chloride-terminated PIB) is refluxed in tetrahydrofuran (THF) (3.0 g/100 ml), and a solution of t-BuOK in THF (2.0 g/30 ml) is added dropwise over a period of 10 minutes, stirred for 20 hours, and then cooled to room temperature. Subsequently, 50 ml n-hexane is added, stirred for a few minutes, 50 ml distilled water introduced, stirred for 10 minutes; the organic layer is then washed three times with 150 ml distilled water each, separated and dried with anhydrous magnesium sulfate. Finally the product is filtered, the solvent removed by evaporation, and dried in vacuo at 75° C. overnight.

For further details, see “New Telechelic Polymers and Sequential Copolymers by Polyfunctional Initiator-Transfer Agents (Inifers) V. Synthesis of α-tert-Butyl-ω-isopropenylpolyisobutylene and α,ω-Di(isopropenyl)polyisobutylene,” Joseph P. Kennedy, Victor S. C. Change, Robert Alan Smith, Bela Ivan, Polymer Bulletin 1, 575-580 (1979), the entire contents of which are incorporated by reference herein.

(II) Unsaturated Acidic Reactant

The term “unsaturated acidic reagent refers to maleic or fumaric reactants of the general formula:

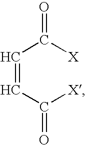

wherein X and X′ are the same or different, provided that at least one of X and X′ is a group that is capable of reacting to esterify alcohols, form amides, or amine salts with ammonia or amines, form metal salts with reactive metals or basically reacting metal compounds and otherwise function as acylating agents. Typically, X and/or X′ is —OH, —O-hydrocarbyl, —OM⁺ where M⁺ represents one equivalent of a metal, ammonium, or amine cation, —NH₂, —Cl, —Br, and taken together X and X′ can be —O— so as to form an anhydride. In some embodiments, X and X′ are such that both carboxylic functions can enter into acylation reactions. Maleic anhydride is one example of a useful unsaturated acidic reactant. Other suitable unsaturated acidic reactants include electron-deficient olefins such as monophenyl maleic anhydride; monomethyl, dimethyl, monochloro, monobromo, monofluoro, dichloro, and/or difluoro maleic anhydride; N-phenyl maleimide and/or other substituted maleimides; iso-maleimides; fumaric acid; maleic acid; alkyl hydrogen maleates and/or fumarates; dialkyl fumarates and/or maleates; fumaronilic acids and/or maleanic acids; and maleonitrile and/or fumaronitrile.

The use of maleic anhydride in copolymers such as those described herein is particularly useful because the resulting succinic anhydride groups throughout the copolymer can subsequently be modified, e.g., as described in greater detail below, in order to further modify the characteristics of the copolymer.

(III) Copolymerization Initiator

A variety of initiators are suitable for use in initiating the copolymerization of the quasi-living polyolefin and the unsaturated acidic reactant. In some embodiments, e.g., embodiments in which the quasi-living polyolefin is produced by polymerizing a monomer in the presence of an initiator, an additional initiator need not be used to initiate the copolymerization reaction. In such embodiments the initiator of the quasi-living reaction can also be used as the initiator of the copolymerization reaction (noting that a copolymerization initiator could also be added). In other embodiments a copolymerization initiator can be added.

In some embodiments, the copolymerization can be initiated by any suitable free radical initiator. Such initiators are well known in the art.

Peroxide-type polymerization initiators, azo-type polymerization initiators, and radiation are examples of useful initiators for copolymerization reactions such as those described herein.

The peroxide-type initiator can be organic or inorganic, in some embodiments the organic having the formula R³OOR^{3′} wherein R³ is any organic radical and R³ is selected from the group consisting of hydrogen and any organic radical. Both R³ and R^{3′} can be organic radicals, e.g., hydrocarbon, aryl and acyl radicals, optionally carrying substituents such as halogens. Some non-limiting examples of useful peroxides include di-tert-amyl peroxide, di-tert-butyl peroxide, tert-butyl peroxybenzoate, dicumyl peroxide, benzoyl peroxide, lauroyl peroxide, other tertiary butyl peroxides, 2,4-dichloro-benzoyl peroxide, tertiary-butyl hydroperoxide, acetyl hydroperoxide, diethylperoxycarbonate, tertiary butyl perbenzoate, and the like.

The azo-type compounds, typified by alpha, alpha′-azobisisobutyronitrile, are also well known free radical promoting materials. The azo compounds can be defined as those having present in the molecule group —N═N— wherein the balances are satisfied by organic radicals, at least one of which is preferably attached to a tertiary carbon. Other suitable azo compounds include, but are not limited to, p-bromo benzenediazonium fluoroborate, p-topydiazoaminobenzene, p-bromobenzenediazonium hydroxide, azomethane, and phenyldiazonium halides.

(IV) Diluents

The copolymerization reaction can be conducted neat, that is, the quasi-living polyolefin, the unsaturated acidic reactant, and the initiator can be combined in the proper ratio and then stirred at the reaction temperature. The unsaturated acidic reactant can be added over time, or all at once.

Alternatively, the reaction can be conducted in a diluent. For example, the reactants can be combined in a solvent. The diluent can be a single compound or a mixture of two or more compounds, that completely, nearly completely, or partially dissolves the reaction components. In some embodiments, the diluent has a low boiling point and/or low freezing point.

A variety of suitable diluents can be used, such as an alkane, an alkyl monohalide, or an alkyl polyhalide. Examples of suitable normal alkanes include propane, normal butane, normal pentane, normal hexane, normal heptane, normal octane, normal nonane and/or normal decane. Examples of suitable branched alkanes include isobutane, isopentane, neopentane, isohexane, 3-methylpentane, 2,2-dimethylbutane, and/or 2,3-dimethylbutane. Examples of suitable halogenated alkanes include chloroform, ethylchloride, n-butyl chloride, methylene chloride, methyl chloride, 1,2-dichloroethane, 1,1,2,2-tetrachloroethane, carbon tetrachloride, 1,1-dichloroethane, n-propyl chloride, iso-propyl chloride, 1,2-dichloropropane, and/or 1,3-dichloropropane.

Alkenes and/or halogenated alkenes can also be used as diluents, e.g., vinyl chloride, 1,1-dichloroethene, or 1,2-dichloroethene. Substituted benzenes are also suitable.

In some embodiments, the diluent is one or more of carbon disulfide, sulfur dioxide, acetic anhydride, acetonitrile, benzene, toluene, ethylbenzene methylcyclohexane, chlorobenzene, and a nitroalkane.

Various mixtures of diluents can be used, e.g., a mixture of hexane and methyl chloride. In some embodiments, such mixture is from about 30/70 to about 70/30 hexane/methyl chloride by volume, or, e.g., from about 50/50 to about 100/0 hexane/methyl chloride by volume, or, e.g., from about 50/50 to about 70/30 hexane/methyl chloride by volume, or, e.g., about 60/40 hexane/methyl chloride by volume, or, e.g., about 50/50 hexane/methyl chloride by volume.

After the reaction is complete, volatile components can be stripped off.

(V) Reaction Conditions

In some embodiments, the amounts of the different reactants and the temperature of reaction are selected to provide the resulting copolymer (e.g., polyPIBSA) with the desired characteristics.

The amount of initiator to employ, exclusive of radiation, depends to a large extent on the particular initiator chosen, the olefin used, and the reaction conditions. In some embodiments, the initiator is soluble in the reaction medium. Exemplary concentrations of initator are between 0.001:1 and 0.20:1 moles of initiator per mole of acidic reactant, e.g., between 0.005:1 and 0.10:1.

In some embodiments, the polymerization temperature is sufficiently high to break down the initiator to produce the desired free-radicals and to maintain the reactants in a liquid phase at the reaction pressure (e.g., atmospheric pressure).

In some embodiments, the reaction time is sufficient to result in the substantially complete conversion of the acidic reactant and quasi-living polyolefin to copolymer. Example reaction times are between one and 24 hours, e.g., between two and 10 hours.

As noted above, the subject reaction occurs in liquid phase. The quasi-living polyolefin, unsaturated acidic reactant, and initiator can be brought together in any suitable manner, e.g., such that the quasi-living polyolefin and unsaturated acidic reactant are brought into intimate contact in the presence of free radicals generated by the initiator. For example, the reaction can be conducted in a batch system where the quasi-living polyolefin is added all initially to a mixture of unsaturated acidic reactant, and initiator; alternately, the quasi-living polyolefin can be added intermittently or continuously to the reaction pot. The reactants can also be added in other orders. For example, the initiator and unsaturated acidic reactant can be added to a reaction pot containing the quasi-living polyolefin. In another manner, the components in the reaction mixture are added continuously to a stirred reactor with continuous removal of a portion of the product to a recovery train or to other reactors in series. The reaction can also suitably take place in a coil-type reactor where the components are added at one or more points along the coil.

After substantial completion of the copolymerization, residual unsaturated acidic reactant can optionally be removed using conventional techniques, e.g., by reducing the pressure over the copolymer to substantially strip off the reactant.

Dispersants Using Copolymers Made with Quasi-Living Polyolefins and Unsaturated Acidic Reactants, and Compositions Including Same

PolyPIBSA copolymers made with quasi-living polyolefins and unsaturated acidic reactants, e.g., using the methods described above, can be reacted with various reactants in order to provide a desired functionality and/or to adjust other characteristics of the copolymers. The resulting polyPIBSA derivatives can then be used in various compositions, such as lubricating oils, fuels, and concentrates.

(I) Post-Treatment of polyPIBSA with Acid to Increase Yield

In some embodiments, the yield of the copolymer, e.g., polyPIBSA, can be increased by reacting the polyPIBSA with an unsaturated acidic reagent at elevated temperature, in the presence of a strong acid. Without being limited to any theory, the unsaturated acidic reactant reacts with residual unreacted polyolefin in the copolymer, thus increasing the yield of the copolymer. The unsaturated acidic reagent can be the same or different as was initially used to form the copolymer (e.g., as described above). The resulting product is a mixture of polyPIBSA and acid-catalyzed thermal PIBSA.

The term “strong acid” refers to an acid having a pKₐ of less than about +4, e.g., about −10 to less than +4, e.g., between about −3 and +2. In some embodiments, the strong acid is an oil-soluble, strong organic acid. Representative classes of the oil-soluble strong acids are represented by maleic acid, malonic acid, phosphoric acid, thiophosphoric acid, phosphonic acid, thiophosphonic acid, sulfonic acid, sulfuric acid, and alpha-substituted or nitrilocarboxylic acids wherein the oil-solubilizing group or groups are hydrocarbyl and contain from 10 to 76 carbon atoms, e.g., 24 to 40 carbon atoms, e.g., 28 to 36 carbon atoms, and the aryl group is, e.g., phenyl. In one example, the strong acid is a sulfonic acid such as an alkyl aryl sulfonic acid, e.g., in which the alkyl group has from 4 to 30 carbon atoms.

The reaction is conducted with an excess of the unsaturated acidic reactant, at elevated temperatures, in the presence of the strong acid. The product of the reaction is referred to herein as “acid-catalyzed thermal PIBSA.”

In some embodiments, the strong acid is present in an amount in the range of, e.g., from 0.0025% to 1.0% based on the total weight of unreacted polyolefin. The unsaturated acidic reactant can be added over a period of time to the copolymer (with residual polyolefin), e.g., from 0.5 to 3 hours, or can be added all at once. The mole ratio of the unsaturated acidic reactant to unreacted polyolefin is at least 1.0:1, e.g., from 1.0:1 to 4.0:1. The temperature can vary over a wide range, e.g., from 180° C. to 240° C., and the pressure can be atmospheric, sub-atmospheric, or super-atmospheric.

When the reaction is complete, the unreacted unsaturated acidic reactant is removed, and the reaction medium cooled, and optionally filtered.

For further details, see U.S. Pat. No. 6,451,920, the entire contents of which are incorporated by reference herein.

(II) Polysuccinimides

A polysuccinimide can be prepared by reacting a copolymer made as described herein, e.g., polyPIBSA made with quasi-living PIB and maleic anhydride, with either an amine or a polyamine, under reactive conditions. Typically, the amine or polyamine is employed in amounts such that there are 0.1 to 1.5 equivalents of amine or polyamine per equivalent of acidic groups in the polyPIBSA/acid-catalyzed thermal PIBSA mixture. In some embodiments, a polyamine is used having at least three nitrogen atoms and 4 to 20 carbon atoms.

It may be desirable to conduct the reaction in an inert organic solvent. Useful solvents will vary and can be determined from literature sources or routine experiments. Typically, the reaction is conducted at temperatures in the range of from about 60° C. to 180° C., e.g., 150° C. to 170° C., for from about 1 to 10 hours, e.g., from about 2 to 6 hours. Typically, the reaction is conducted at about atmospheric pressure; however, higher or lower pressures can also be used depending on the reaction temperature desired and the boiling point of the reactants or solvent.

Water, present in the system or generated by this reaction, can be removed from the reaction system during the course of the reaction via azeotroping or distillation. After reaction completion, the system can be stripped at elevated temperatures (typically 100° C. to 250° C.) and reduced pressures to remove any volatile components that may be present in the product.

An amine or a polyamine is used, e.g., a polyamine with at least three amine nitrogen atoms per molecule, e.g., 4 to 12 amine nitrogens per molecule. Polyamines having from about 6 to 10 nitrogen atoms per molecule can also be used. Some useful polyalkene polyamines also contain from about 4 to 20 carbon atoms, e.g., from 2 to 3 carbon atoms per alkylene unit, and in some embodiments have a carbon-to-nitrogen ratio of from 1:1 to 10:1. Non-limiting examples of suitable polyamines that can be used to form succinimides of copolymers such as those described herein include the following: tetraethylene pentamine, pentaethylene hexamine, Dow E-100 heavy polyamine (Mₙ=303, available from Dow Chemical Company), and Union Carbide HPA-X heavy polyamine (Mₙ=275, available from Union Carbide Corporation). Such polyamines encompass isomers, such as branched-chain polyamines, and substituted polyamines, including hydrocarbyl-substituted polyamines. HPA-X heavy polyamine contains an average of approximately 6.5 amine nitrogen atoms per molecule.

The polyamine reactant can be a single compound or a mixture of compounds reflecting commercial polyamines. Typically, commercial polyamines are a mixture in which one or several compounds predominate with the average composition indicated. For example, tetraethylene pentamine prepared by the polymerization of aziridine or the reaction of dichloroethylene and ammonia typically includes both lower and higher amine members, e.g., triethylene tetramine, substituted piperazines and pentaethylene hexamine, but the composition is largely tetraethylene pentamine and the empirical formula of the total amine composition closely approximates that of tetraethylene pentamine.

Other examples of suitable polyamines include admixtures of amines of various molecular weights. Included are mixtures of diethylene triamine and heavy polyamine. One exemplary polyamine admixture is a mixture containing 20% by weight diethylene triamine and 80% by weight heavy polyamine.

In some embodiments in which an amine, e.g., a monoamine, are employed, the amine is a primary amine, secondary amine, or mixture thereof, and can have at least 10 carbon atoms, e.g., between 12 and 18 carbon atoms. Aromatic, aliphatic, saturated, and unsaturated amines may be employed. Useful amines include aliphatic primary amines. Examples of suitable amines include, but are not limited to, octadecylamine and dodecylamine. An example of a suitable mixture of amines is tallowamine (a partially saturated mixture of amines including mainly C₁₈ amines).

Mixtures of monoamines and polyamines can be used. Also, polyoxyalkylene polyamines (for example, materials supplied under the trade name Jeffamine) and aminoalcohols can also be suitably used.

(III) Polyesters

Polyesters can be prepared by reacting a copolymer made as described herein, e.g., polyPIBSA made with quasi-living PIB and maleic anhydride, with a polyol, under reactive conditions. The polyols have the formula R″(OH)ₓ where R″ is a hydrocarbon radical and x is an integer representing the number of hydroxy radicals and has a value of from 2 to about 10. In some embodiments, the polyols contain less than 30 carbon atoms, and have from 2 to about 10, e.g., 3 to 6, hydroxy radicals. They are illustrated by, for example, alkylene glycols and poly(oxyalkylene) glycols such as ethylene glycol, di(ethylene glycol), tri(ethylene glycol), di(propylene glycol), tri(butylene glycol), penta(ethylene glycol), and other poly(oxyalkylene) glycols formed by the condensation of two or more moles of ethylene glycol, propylene glycol, octylene glycol, or a like glycol having up to 12 carbon atoms in the alkylene radical. Other useful polyhydric alcohols include glycerol, pentaerythritol, 2,4-hexanediol, pinacol, erythritol, arabitol, sorbitol, mannitol, 1,2-cyclohexanediol, xylylene glycol, and 1,3,5-cyclohexanetriol. Other useful polyols are disclosed in U.S. Pat. No. 4,034,038, issued Jul. 5, 1977 to Vogel, which is incorporated by reference in its entirety.

Esterification can be effected, for example, at a temperature of about 100° C. to about 180° C., e.g., about 150° C. to about 160° C. Ordinarily, the reaction is carried out at substantially atmospheric pressure, although pressures above atmospheric can be employed, e.g., with more volatile reactants. In some embodiments, stoichiometric amounts of reactants are employed. The reaction can be run in the absence of a catalyst, or in the presence of an acid-type catalyst such as mineral acids, sulfonic acids, Lewis type acids and the like. Suitable reaction conditions and catalysts are disclosed in U.S. Pat. No. 3,155,686, issued Nov. 3, 1964 to Prill et al., which is incorporated by reference in its entirety.

(IV) Post-Treatment of Polysuccinimides

The dispersancy and other properties of polysuccinimides made as described above, e.g., polysuccinimides made using polyPIBSA made with quasi-living PIB and maleic anhydride, can be further modified by reaction with a cyclic carbonate. The resulting post-treated product has one or more nitrogens of the polyamino moiety substituted with a hydroxy hydrocarbyl oxycarbonyl, a hydroxy poly(oxyalkylene) oxycarbonyl, a hydroxyalkylene, hydroxyalkylenepoly(oxyalkylene), or mixture thereof.

In some embodiments, the cyclic carbonate post-treatment is conducted under conditions sufficient to cause reaction of the cyclic carbonate with secondary amino groups of the polyamino substituents. Typically, the reaction is conducted at temperatures of about 0° C. to 250° C., e.g., from 100° C. to 200° C., e.g., from about 150° C. to 180° C.

The reaction can be conducted neat, and optionally is conducted in the presence of a catalyst (such as an acidic, basic or Lewis acid catalyst). Depending on the viscosity of the reactants, it may be useful to conduct the reaction using an inert organic solvent or diluent, e.g., toluene or xylene. Examples of suitable catalysts include phosphoric acid, boron trifluoride, alkyl or aryl sulfonic acid, and alkali or alkaline earth carbonate.

One example of a useful cyclic carbonate is 1,3-dioxolan-2-one (ethylene carbonate), which affords suitable results and is readily available commercially.

The molar charge of cyclic carbonate employed in the post-treatment reaction is, in some embodiments, based upon the theoretical number of basic nitrogen atoms contained in the polyamino substitutent of the succinimide. Without wishing to be bound by theory, when one equivalent of tetraethylene pentamine is reacted with two equivalents of succinic anhydride, the resulting bis-succinimide will theoretically contain three basic nitrogen atoms. Accordingly, a molar charge ratio of 2 would theoretically require that two moles of cyclic carbonate be added for each basic nitrogen, or in this case 6 moles of cyclic carbonate for each mole equivalent of succinimide. Mole ratios of the cyclic carbonate to the basic amine nitrogen are typically in the range of from about 1:1 to about 4:1; preferably from about 2:1 to about 3:1.

The dispersancy and other properties of polysuccinimides made as described above, e.g., polysuccinimides made using polyPIBSA made with quasi-living PIB and maleic anhydride, can be further modified by reaction with boric acid or a similar boron compound to form borated dispersants. In addition to boric acid, examples of suitable boron compounds include boron oxides, boron halides and esters of boric acid. In some embodiments, from about 0.1 equivalent to about 1 equivalent of boron compound per equivalent of basic nitrogen or hydroxyl in the compositions of this invention may be employed.

(V) Lubricating Oil Compositions and Concentrates

Polysuccinimides based on polyPIBSA made with quasi-living PIB and maleic anhydride, such as those described above, are useful as detergent and dispersant additives in lubricating oils. Typically, when employed in crankcase oils, such polysuccinimides can be used in amounts of about 1 to about 10 percent by weight (on an actives basis) of the total composition, e.g., less than about 5 percent by weight (on an actives basis). Actives basis indicates that only the active ingredients of the polysuccinimides are considered when determining the amount of the additive relative to the remainder of a composition. Diluents and any other inactives, such as unreacted polyolefin, are excluded. Unless otherwise indicated, in describing the lubricating oil and final compositions or concentrates, active ingredient contents are intended with respect to the polysuccinimides.

The lubricating oil used with the polysuccinimides may be mineral or synthetic oils of lubricating viscosity and preferably suitable for use in the crankcase of an internal combustion engine. Crankcase lubricating oils typically have a viscosity of about 1300 cSt at 0° F. (−17.8° C.) to 22.7 cSt at 210° F. (99° C.). Useful mineral oils include paraffinic, naphthenic and other oils that are suitable for use in lubricating oil compositions. Synthetic oils include both hydrocarbon synthetic oils and synthetic esters. Useful synthetic hydrocarbon oils include polymers of alpha olefins having suitable viscosity, e.g., the hydrogenated liquid oligomers of C₆ to C₁₂ alpha olefins, such as 1-decene trimer. Likewise, alkyl benzenes of proper viscosity such as didodecyl benzene can be used. Useful synthetic esters include the esters of both monocarboxylic acids and polycarboxylic acids as well as monohydroxy alkanols and polyols. Examples are didodecyl adipate, pentaerythritol tetracaproate, di-2-ethylhexyl adipate, dilaurylsebacate and the like. Complex esters prepared from mixtures of mono and dicarboxylic acid and mono and dihydroxy alkanols can also be used.

Blends of hydrocarbon oils and synthetic oils are also useful. For example, blends of 10 to 25 weight percent hydrogenated 1-decene trimer with 75 to 90 weight percent 150 SUS (100° F.) mineral oil gives an excellent lubricating oil base.

Other additives which may be present in the formulation include detergents (overbased and non-overbased), rust inhibitors, foam inhibitors, metal deactivators, pour point depressants, antioxidants, wear inhibitors, zinc dithiophosphates and a variety of other well known additives.

It is also contemplated that polysuccinimides prepared as described above can be employed as dispersants and detergents in hydraulic fluids, marine crankcase lubricants and the like. In some embodiments, the polysuccinimide is added at from 0.1 to 5 percent by weight (on an active polysuccinimide basis) to the fluid, and preferably at from 0.5 to 5 weight percent (on an active polysuccinimide basis).

Polysuccinimides can also be used in additive concentrates, which in some embodiments include from 90 to 10 percent, e.g., 20 to 60 weight percent, of an organic liquid diluent and from 10 to 90 weight percent, e.g., 80 to 40 weight percent, (on a dry basis) of the polysuccinimide. Typically, the concentrates contain sufficient diluent to make them easy to handle during shipping and storage. Suitable diluents for the concentrates include any inert diluent, preferably an oil of lubricating viscosity, so that the concentrate may be readily mixed with lubricating oils to prepare lubricating oil compositions. Suitable lubricating oils which can be used as diluents typically have viscosities in the range from about 1300 cSt at 0° F. (−17.8° C.) to 22.7 cSt at 210° F. (99° C.), although an oil of lubricating viscosity can be used.

(E) Fuel Compositions and Concentrates

When used in fuels, useful concentrations of polysuccinimides prepared as described above, to obtain the desired detergency, is dependent upon a variety of factors including the type of fuel used, the presence of other detergents or dispersants or other additives, etc. In some embodiments, the range of concentration of the polysuccinimide in the base fuel is 10 to 10,000 weight parts per million, e.g., from 30 to 5,000 parts per million. If other detergents are present, a lesser amount of the polysuccinimide may be used. The polysuccinimides can also be formulated as a fuel concentrate, using an inert stable oleophilic solvent boiling in the range of about 150-400° F. (65.6-204.4° C.). Useful solvents boil in the gasoline or diesel fuel range. In some embodiments, an aliphatic or an aromatic hydrocarbon solvent is used, such as a benzene, toluene, xylene or higher-boiling aromatics or aromatic thinners. Aliphatic alcohols of about 3 to 8 carbon atoms, such as isopropanol, isobutylcarbinol, n-butanol and the like in combination with hydrocarbon solvents are also suitable for use with the polysuccinimide. In the fuel concentrate, the amount of the polysuccinimide will, in some embodiments, be at least 5 percent by weight and not more 70 percent by weight, e.g., from 5 to 50, e.g., from 10 to 25 weight percent.

### EXAMPLES

The invention is further illustrated by the following examples, which are not to be considered as limitative of its scope.

### Example A

### Synthesis of Exo-Olefin Terminated Quasi-living Polyisobutylene

A 4 neck, 5 L round bottom flask equipped with an overhead stirrer and thermocouple was submerged in a heptane bath maintained at −60° C. The apparatus and bath were enclosed within a glove box containing anhydrous nitrogen as the inert atmosphere. The following were charged to the round bottom flask: 2144.7 mL hexane, 1429.8 mL methylchloride, 422.5 mL isobutylene (5.17 mol), 19.95 g 2-chloro-2,4,4-trimethylpentane (0.134 mol), 14.2 mL 2,6-Lutidine, and 1.14 g tetra-n-butylammonium chloride. The mixture was allowed to stir until the solution reached thermal equilibrium at −60 C. Then, 64.7 mL (0.59 mol) TiCl₄ was charged to the reactor to initiate the isobutylene polymerization. The polymerization was allowed to proceed for 15 min, at which time 23.2 mL (0.228 mol) 2,5-dimethylpyrrole was charged to the reactor. The mixture was stirred for an additional 57 min., and the reaction was then terminated with 107.5 mL (2.657 mol) methanol.

The mixture was removed from the glove box and the volatiles were evaporated overnight under ambient conditions. The organic layer was extracted repeatedly with a 5% HCl/deionized H₂O solution, washed with deionized H₂O until neutral, and then dried over magnesium sulfate. The organic layer was then filtered through both Celite and silica gel and finally, the hexane was removed via vacuum distillation to afford approximately 275 g PIB. The product contained 97% exo-olefin end-group content, had Mₙ=2278 and a DI=1.05.

### Example B

### Synthesis of Exo-Olefin Terminated Quasi-living Polyisobutylene

The quasi-living PIB (Mₙ=1007) was prepared using the same procedure as in Example A except that we used 1002.8 mL hexane, 936.5 mL methylchloride, 402 mL isobutylene (4.80 mol), 43.249 g 2-chloro-2,4,4-trimethylpentane (0.291 mol), 1.248 mL 2,6-Lutidine, and 1.668 g tetra-n-butylammonium chloride. To this mixture at −45° C. was added 13.8 g TiCl₄ (0.073 mol). The polymerization was allowed to proceed for 60 minutes at which time 46.29 mL isopropylsulfide (0.319 mol) was added followed by an additional 96.05 g TiCl₄ (0.506 mol). The mixture was stirred for an additional four minutes at which time n-butylamine 185.99 g (2.543 mol) was added. The temperature rose up to −15° C. briefly. After an additional six minutes the temperature had cooled back down to −24° C. and 94.15 mL methanol (2.327 mol) was added to terminate the reaction. The product from this reaction was purified by washing with dilute hydrochloric acid solution, then with water, and then was dried with anhydrous magnesium sulfate, followed by filtration. The product was further purified by passing this material through a column of 200-450 mesh silica gel (100 g) and eluting with hexane. The hexane was removed in vacuo to give the PIB product. The PIB product from this reaction had a Mₙ=1007, a DI=1.10 and 94% exo-olefin end-group content.

### Example 1

### PolyPIBSA from Quasi-living Polyisobutylene

To a 500 mL flask equipped with a condenser, overhead stirrer, heating mantle and two syringe pumps was added quasi-living PIB from Example B (86 g, 0.085 mol, Mₙ=1007, DI=1.10, and 94% exo-olefin end-group content). The temperature was increased to 150° C. Di-tert-amyl peroxide (1.59 g, 0.0091 mol) and maleic anhydride (15.44 g, 0.157 mol) were added separately via two syringe pumps over a 2 h period. The maleic anhydride was heated to greater than 80° C. so that the sample was a liquid. Both syringe needles were positioned below the surface of the liquid so that the tips of the needles were just touching each other. The reaction was heated for an additional 2 h. Then the excess maleic anhydride was removed by distillation at reduced pressure at 180° C. over a 2 h period. The polyPIBSA had a SAP number (saponification number as determined by ASTM D94) of 141.4 mg KOH/g and contained 90.2 wt % actives. The succinic ratio was 1.6. The succinic ratio refers to the ratio calculated in accordance with the procedure and mathematical equation set forth in columns 5 and 6 of U.S. Pat. No. 5,334,321, which is hereby incorporated by reference in its entirety. Normally, the succinic ratio refers to the number of succinic groups per polybutene tail. In the context of this application, the succinic ratio refers to the ratio of succinic anhydride groups to polybutene tails that are present in the polyPIBSA copolymer.

### Example 2 (Comparative)

### PolyPIBSA from Non-Quasi-Living Polyisobutylene

PolyPIBSA derived from non-quasi-living PIB was prepared in a manner identical to that described in Example 1 except that 100 g of non-quasi-living PIB prepared by the BF₃ catalyzed polymerization of isobutylene (0.096 mol, Mₙ=1046, DI=1.71, 83% exo-olefin end-group content), 1.74 g of di-tert-amyl peroxide (0.01 mol) and 15 g of maleic anhydride (0.153 mol) were used. This polyPIBSA had a SAP number of 123.7 mg KOH/g and contained 81.6 wt % actives. The succinic ratio was 1.6.

### Example 3

### PolyPIBSA from Quasi-Living Polyisobutylene

PolyPIBSA derived from quasi-living PIB prepared in Example A was prepared in a manner identical to that described in Example 1 except that 90.1 g (0.04 mol) of quasi-living PIB having a number average molecular weight of 2278, DI=1.05, and 97% exo-olefin end-group content, 1.2 g of di-tert-amyl peroxide (0.007 mol), and 6.32 g maleic anhydride (0.06 mol) were used. The product polyPIBSA had a SAP number of 58.6 mg KOH/g sample, 84.7% actives, and a succinic ratio of 1.5.

### Example 4 (Comparative)

### PolyPIBSA from Non-Quasi-Living Polyisobutylene

PolyPIBSA derived from a non-quasi-living PIB was prepared in a manner identical to that described in Example 1 except that 97.5 g (0.041 mol) non-quasi-living PIB prepared by the BF₃ catalyzed polymerization of isobutylene having a number average molecular weight of 2389, DI=1.89, and 85% exo-olefin end-group content, 1.28 g of di-tert-amyl peroxide (0.0074 mol), and 6.4 g maleic anhydride (0.07 mol) were used. The product polyPIBSA had a SAP number=56.1 mg KOH/g sample, 73.7% actives, and 1.7 succinic ratio.

The data from Examples 1 to 4 are summarized in Table 1.

TABLE 1
Chemical and physical properties for polyPIBSAs in Examples 1-4

| | | | PIB | | | |
|---|---|---|---|---|---|---|
| | PIB | PIB | % exo-olefin | polyPIBSA | polyPIBSA | polyPIBSA |
| Sample | Mₙ | DI | end groups | SAP, mg KOH/g | % actives | succinic ratio |
| Example 1 | 1007 | 1.10 | 94 | 141.4 | 90.2 | 1.6 |
| Example 2 | 1046 | 1.71 | 83 | 123.7 | 81.6 | 1.6 |
| (Comparative) | | | | | | |
| Example 3 | 2278 | 1.05 | 97 | 58.6 | 84.7 | 1.5 |
| Example 4 | 2389 | 1.89 | 85 | 56.1 | 73.7 | 1.7 |
| (Comparative) | | | | | | |

The results show that polyPIBSAs prepared from quasi-living PIB usefully have higher SAP numbers and higher % actives, at about the same succinic ratio, than polyPIBSAs prepared from the non-quasi-living PIB. Without wishing to be bound by theory, it is believed that the higher % actives and the higher SAP numbers is based at least in part on the fact that quasi-living PIB contains higher % exo-olefin end-group content than the non-quasi-living PIB. The 1000 molecular weight polyPIBSAs also had, in general, higher SAP numbers than the 2300 molecular weight polyPIBSAs; without wishing to be bound by theory, it is believed that this is because the anhydride groups have a greater percentage of the total weight for the 1000 molecular weight polyPIBSAs compared to the 2300 molecular weight polyPIBSAs. The 1000 molecular weight polyPIBSAs had higher % actives than the 2300 molecular weight polyPIBSAs; without wishing to be bound by theory, it is believed that this is because the concentration of the double bond (mmol/mL) is greater for the 1000 molecular weight PIB than for the 2300 molecular weight PIB and therefore the 1000 molecular weight PIB reacts at a higher rate.

### Comparison of Results for Examples 1-4

Multigrade oils (for example a 10W30 oil) meet the SAE 10W viscosity limit at low temperature and the SAE 30 viscosity limit at high temperature. Examples of ways to meet the desired viscosity targets are to use: 1) blends of different viscosity base oils (for example 100 neutral plus 600 neutral oils), 2) unconventional base oils with high viscosity index (VI), 3) a detergent/inhibitor additive package with a lower Cold Crank Simulator (CCS) thickening and 4) viscosity index improvers (VI improvers) which improve the viscosity index of formulated oils. The use of appropriate combinations of these four variables can produce formulated oils with high kinematic viscosity (kv) at 100° C. and low CCS viscosity at for example −20° C.

Under certain conditions, e.g., for a high fuel economy passenger car motor oil (PCMO) formulation it may be useful for a dispersant to have both a low CCS viscosity and a low kv. This can be determined by measuring the CCS and the kv for a dispersant dissolved in a diluent oil. A dispersant with a lower CCS and kv may exhibit improved performance.

Under other conditions, it is sometimes useful for the dispersant to have a high kv and a low CCS viscosity so that less VI improver is needed to meet the desired viscosity grade This can be determined by plotting the CCS versus kv and measuring the slope. The dispersant with the lowest slope may have improved performance.

In order to demonstrate the improved low temperature properties discussed above for polyPIBSA derived from quasi-living PIB compared to the non-quasi-living PIB, the Cold Cranking Simulator (CCS) viscosity and the kinematic viscosity (kv) were measured for the products of Examples 1 to 4. The results are presented in Table 2. For this analysis the polyPIBSAs in Examples 1-4 were first dissolved in Chevron 100 neutral diluent oil at a dose of 4 wt % and 8 wt %. Chevron 100 neutral diluent oil is a group 2 diluent oil. The kinematic viscosity (kv @ 100° C.) was measured using ASTM D445. The cold crank simulator (CCS) was measured using ASTM D5293. These results are shown in Table 2.

TABLE 2

| | | | | Dose | CCS | kv | CCS vs kv plot |
|---|---|---|---|---|---|---|---|
| Example | PIB Source | PIB Mₙ | DI | (wt %) | (cP) | (cSt) | slope |
| 1 | quasi-living | 1007 | 1.10 | 4 | 1075 | 4.692 | 440 |
| | | | | 8 | 1475 | 5.526 | |
| 2 | Non-quasi-living | 1046 | 1.71 | 4 | 1163 | 4.851 | 494 |
| (Comparative) | | | | 8 | 1714 | 5.851 | |
| 3 | quasi-living | 2278 | 1.05 | 4 | 1276 | 5.003 | 495 |
| | | | | 8 | 2053 | 6.267 | |
| 4 | Non-quasi-living | 2389 | 1.89 | 4 | 1479 | 5.582 | 437 |
| (Comparative) | | | | 8 | 2643 | 7.563 | |

The results show that for both polyPIBSA from ˜1000 MW PIB and polyPIBSA from ˜2300 MW PIB the CCS viscosity and kv were lower for the polyPIBSA derived from quasi-living PIB compared to the polyPIBSA derived from the non-quasi-living PIB. Without wishing to be bound by theory, believe that this is due to the fact that the quasi-living PIB that was used to make the polyPIBSAs in Examples 1 and 3 had a lower dispersion index (DI=1.05-1.11) than the non-quasi-living PIB (DI=1.71-1.89) that was used to make the polyPIBSAs in Examples 2 and 4. This indicates that polyPIBSA made from quasi-living PIB would be expected to give better performance than polyPIBSA made from non-quasi-living PIB in an oil where a high fuel economy PCMO formulation is desired.

In Table 3, the slope of the CCS versus kv plot for the polyPIBSA made from the quasi-living PIB (˜1000 MW) was lower than the slope for the polyPIBSA made from the non-quasi-living PIB (1000 MW). This means that polyPIBSA made from quasi-living PIB (11000 MW) would be expected to perform better than polyPIBSA made from non-quasi-living PIB (˜1000 MW) in an oil where less VI improver is needed to meet the desired viscosity grade.

### Example 5

### Preparation of bis TEPA Polysuccinimide from polyPIBSA Made Using Quasi-Living PIB

To a 4-neck 250 mL round bottom flask equipped with an overhead stirrer, condenser, Dean Stark trap, heating mantle, temperature controller, and nitrogen inlet tube was added 26.62 g (33.5 mmol) polyPIBSA (‘quasi living’) from example 1. To this was added 21.38 g Chevron 100N diluent oil. The temperature was increased to 150° C. and to this was added 3.17 g TEPA (16.8 mmol). The amine/anhydride CMR=0.5. The temperature was increased to 170° C. and kept there overnight. The color turned brown. Then the reaction was cooled. The product polysuccinimide (52% actives) had 2.9% N and vis @ 100° C.=6725 cSt.

### Example 6 (Comparative)

### Preparation of bis TEPA Polysuccinimide from polyPIBSA Made Using Non-Quasi-Living PIB

To a 4-neck 500 mL round bottom flask equipped with an overhead stirrer, condenser, Dean Stark trap, heating mantle, temperature controller, and nitrogen inlet tube was added 43.54 g (48.0 mmol) polyPIBSA (non-quasi-living) from example 2. To this was added 27.52 g Chevron 100N diluent oil. The temperature was increased to 150° C. and to this was added 4.53 g TEPA (24.0 mmol). The amine/anhydride CMR=0.5. The temperature was increased to 170° C. and kept there overnight. The color turned dark brown. Then the reaction was cooled. The product polysuccinimide (52% actives) had 2.5% N and vis @ 100° C.=672.1 cSt.

### Example 7

### Preparation of bis HPA Polysuccinimide from polyPIBSA Made Using Quasi-Living PIB

To a 4-neck 250 mL round bottom flask equipped with an overhead stirrer, condenser, Dean Stark trap, heating mantle, temperature controller, and nitrogen inlet tube was added 25.37 g (13.2 mmol) polyPIBSA (quasi-living) from example 3. To this was added 17.61 g Chevron 100N diluent oil. The temperature was increased to 150° C. and to this was added 1.64 g HPA (6.0 mmol). The amine/anhydride CMR=0.45. The temperature was increased to 170° C. and kept there 7 hrs. Then the reaction was cooled. The product polysuccinimide (52% actives) had 1.2% N and vis@100° C.=492 cSt.

### Example 8 (Comparative)

### Preparation of bis HPA Polysuccinimide from polyPIBSA Made Using Non-Quasi-Living PIB

To a 4-neck 250 mL round bottom flask equipped with an overhead stirrer, condenser, Dean Stark trap, heating mantle, temperature controller, and nitrogen inlet tube was added 30.45 g (15.2 mmol) polyPIBSA (non-quasi-living) from example 4. To this was added 14.43 g Chevron 100N diluent oil. The temperature was increased to 150° C. and to this was added 1.88 g HPA (6.8 mmol). The amine/anhydride CMR=0.45. The temperature was increased to 170° C. and kept there 7 hrs. Then the reaction was cooled. The product polysuccinimide (51% actives) had 1.5% N and vis@100° C.=1414 cSt.

TABLE 3
Chemical and physical properties for polyPIBSAs in Example 5-8

| | PIB | PIB | | | polysuccinimide | Viscosity @100° C., |
|---|---|---|---|---|---|---|
| Sample | Mₙ | DI | Amine | % N | % actives | cSt |
| Example 5 | 1007 | 1.10 | TEPA | 2.9 | 52 | 6725 |
| Example 6 | 1046 | 1.71 | TEPA | 2.5 | 52 | 672 |
| (Comparative) | | | | | | |
| Example 7 | 2278 | 1.05 | HPA | 1.2 | 52 | 492 |
| Example 8 | 2389 | 1.89 | HPA | 1.5 | 51 | 1414 |
| (Comparative) | | | | | | |

The data in Table 3 shows that the % N for the polysuccinimides made from 1000 molecular weight PIB were higher than the % N for the polysuccinimides made from the 2300 molecular weight PIB at equal actives. The viscosity @ 100° C. for the polysuccinimide made from the 1000 molecular weight ‘quasi-living’ PIB was much higher (6725 cSt, Example 5) than the viscosity 100° C. for the polysuccinimide made from the 1000 molecular weight non-quasi-living PIB (672 cSt, Example 6). The viscosity of the polysuccinimide made from the 2300 molecular weight quasi-living PIB was lower (492 cSt, Example 7) compared to the viscosity of the polysuccinimide made from the 2300 molecular weight non-quasi-living PIB (1414 cSt, Example 8).

### Comparison of Results for Examples 5-8

In order to demonstrate improved low temperature properties for polysuccinimides derived from quasi-living PIB, the Cold Cranking Simulator (CCS) viscosity and the kinematic viscosity (kv) were measured for the products of Examples 5 to 8. The results are presented in Table 4. For this analysis the polysuccinimides in Examples 5-8 were first dissolved in Chevron 100 neutral diluent oil at a dose of 4 wt % and 8 wt %. Chevron 100 neutral diluent oil is a group 2 diluent oil.

TABLE 4

| | | | | Dose | CCS | kv | CCS vs kv plot |
|---|---|---|---|---|---|---|---|
| polysuccinimide | PIB | PIB Mₙ | Amine | (wt %) | (cP) | (cSt) | slope |
| Example 5 | quasi-living | 1007 | TEPA | 4 | 1028 | 5.023 | 186 |
| | | | | 8 | 1290 | 6.369 | |
| Example 6 | Non-quasi-living | 1046 | TEPA | 4 | 1034 | 4.761 | 271 |
| (Comparative) | | | | 8 | 1293 | 5.659 | |
| Example 7 | quasi-living | 2278 | HPA | 4 | 1070 | 4.779 | 335 |
| | | | | 8 | 1390 | 5.641 | |
| Example 8 | Non-quasi-living | 2389 | HPA | 4 | 1114 | 5.048 | 297 |
| (Comparative) | | | | 8 | 1531 | 6.323 | |

The results show that both the CCS viscosity and the kv for the polysuccinimide made from the 2300 molecular weight quasi-living PIB were lower than the CCS viscosity and the kv for the polysuccinimide made from the 2300 molecular weight non-quasi-living PIB. This indicates that polyPIBSA made from the 2300 molecular weight quasi-living PIB would be expected to give better performance than polyPIBSA made from the 2300 molecular weight non-quasi-living PIB in an oil where a high fuel economy PCMO formulation is desired. This was not the case for the polysuccinimide made from the 1000 molecular weight quasi-living PIB. In this case the CCS viscosity was about the same as the CCS viscosity for the polysuccinimide made from the 1000 molecular weight non-quasi-living PIB. Moreover, the kv for the polysuccinimide made from the 1000 molecular weight quasi-living PIB was greater than the kv for the polysuccinimide made from the 1000 molecular weight non-quasi-living PIB. This indicates that polyPIBSA made from the 1000 molecular weight quasi-living PIB may not give better performance than polyPIBSA made from the 1000 molecular weight non-quasi-living PIB where a high fuel economy PCMO formulation is desired.

The slope of the CCS versus kv plot for the polysuccinimide made from the 1000 molecular weight quasi-living PIB (slope=186) was lower than the slope for the polysuccinimide made from the 1000 molecular weight non-quasi-living PIB (slope=271). This means that the polysuccinimide made from the 1000 molecular weight quasi-living PIB would be expected to perform better than the polysuccinimide made from the 1000 molecular weight non-quasi-living PIB in an oil where less VI improver is needed to meet the desired viscosity grade. This was not true for the polysuccinimide made from the 2300 molecular weight quasi-living PIB in an oil where less VI improver is needed to meet the desired viscosity grade.

While the present invention has been described with reference to specific embodiments, this application is intended to cover those various changes and substitutions that may be made by those skilled in the art without departing from the spirit and scope of the appended claims.

What is claimed:

1. A copolymer of an unsaturated acidic reactant and a high molecular weight polyolefin, wherein the polyolefin comprises an exo-olefin terminated quasi-living polyolefin.

2. The copolymer of claim 1, wherein the quasi-living polyolefin is produced by:
(a) forming a quasi-living cationic polyolefin under suitable quasi-living conditions, and
(b) contacting the quasi-living cationic polyolefin with a quenching agent selected to convert the cationic polyolefin to the exo-olefin terminated quasi-living polyolefin.

3. The copolymer of claim 2, wherein the cationic polyolefin is formed by contacting at least one cationically polymerizable monomer with an initiator, in the presence of a Lewis acid and diluent under suitable quasi-living conditions.

4. The copolymer of claim 2, wherein the cationic polyolefin is formed by ionizing a tert-halide terminated polyolefin with a Lewis acid.

5. The copolymer of claim 2, wherein the quenching agent comprises at least one of a substituted pyrrole, a substituted imidazole, a hindered secondary amine, a hindered tertiary amine, and a dihydrocarbylmonosulfide.

6. The copolymer of claim 1, wherein the quasi-living product is formed by contacting a tert-halide terminated polyolefin with potassium tert-butoxide.

7. The copolymer of claim 1, wherein the copolymer is formed by contacting the polyolefin with the unsaturated acidic reactant in the presence of an initiator.

8. The copolymer of claim 7, wherein the initiator comprises a peroxide.

9. The copolymer of claim 1, wherein the polyolefin has a molecular weight between about 500 and about 10,000.

10. The copolymer of claim 1, wherein the polyolefin has a molecular weight between about 900 and about 5,000.

11. The copolymer of claim 1, wherein the copolymer has a succinic ratio of between about 1 and about 3.

12. The copolymer of claim 1, wherein the copolymer has a succinic ratio of between about 1.3 and about 1.8.

13. The copolymer of claim 1, wherein the polyolefin has an exo-olefin end-group content of at least 90%.

14. The copolymer of claim 1, wherein the polyolefin has an exo-olefin end-group content of at least 95%.

15. The copolymer of claim 1, wherein the polyolefin has a dispersion index of less than about 1.4.

16. The copolymer of claim 1, wherein the polyolefin has a dispersion index of less than about 1.1.

17. The copolymer of claim 1, wherein the unsaturated acidic reactant is of the formula: 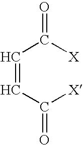
wherein X and X′ are each independently selected from the group consisting of —OH, —Cl, —O-lower alkyl, and when taken together, X and X′ are —O—.

18. The copolymer of claim 17, wherein the acidic reactant comprises maleic anhydride.

19. The copolymer of claim 1, wherein the high molecular weight polyolefin comprises a high molecular weight alkylvinylidene polyolefin having at least one branch per 2 carbon atoms along the chain.

20. The copolymer of claim 3, wherein the cationically polymerizable monomer comprises isobutylene.

21. The copolymer of claim 1, wherein the copolymer has the formula: 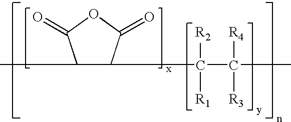
wherein n is 1 or greater;
wherein either:
a. R₁ and R₂ are hydrogen and one of R₃ and R₄ is lower alkyl and the other is high molecular weight polyalkyl, or
b. R₃ and R₄ are hydrogen and one of R₁ and R₂ is lower alkyl and the other is high molecular weight polyalkyl; and
wherein each of x, y, and n is, independently, 1 or greater, and wherein the ratio of x:y is less than 3:1.

22. The copolymer of claim 21, wherein each of x and y is, independently, between 1 and 3, and wherein n is between 1 and 20.

23. The copolymer of claim 21, wherein the high molecular weight polyalkyl comprises a polyisobutyl group having at least 30 carbon atoms.

24. The copolymer of claim 21, wherein the lower alkyl is a methyl.

25. A polysuccinimide prepared by reacting the copolymer of claim 1 with an amine, a polyamine having at least two basic nitrogens, or mixtures thereof.

26. A lubricating oil composition comprising a major amount of an oil of lubricating viscosity and a minor amount of the polysuccinimide of claim 25.

27. A method of making a copolymer comprising:
a. forming a high molecular weight, exo-olefin terminated quasi-living polyolefin; and
b. contacting the polyolefin with an unsaturated acidic reactant in the presence of an initiator to form a copolymer.

28. The method of claim 27, wherein the exo-olefin terminated quasi-living polyolefin is produced by:
(a) forming a quasi-living cationic polyolefin under suitable quasi-living conditions, and
(b) contacting the quasi-living cationic polyolefin with a quenching agent selected to convert the quasi-living cationic polyolefin to the high molecular weight, exo-olefin terminated quasi-living polyolefin.

29. The method of claim 28, wherein the quasi-living cationic polyolefin is prepared by contacting at least one cationically polymerizable monomer with an initiator, in the presence of a Lewis acid and diluent under suitable quasi-living conditions.

30. The method of claim 28, wherein the quasi-living cationic polyolefin is prepared by ionizing a tert-halide terminated polyolefin with a Lewis acid.

31. The method of claim 28, wherein the quenching agent comprises at least one of a substituted pyrrole, a substituted imidazole, a hindered secondary amine, a hindered tertiary amine, and a dihydrocarbylmonosulfide.

32. The method of claim 27, wherein forming the polyolefin comprises contacting a tert-halide terminated polyolefin with potassium tert-butoxide.

33. The method of claim 29, wherein the initiator comprises a peroxide.

34. The method of claim 27, wherein the polyolefin has a molecular weight between about 500 and about 10,000.

35. The method of claim 27, wherein the polyolefin has a molecular weight between about 900 and about 5000.

36. The method of claim 27, wherein the polyolefin has an exo-olefin end-group content of at least 90%.

37. The method of claim 27, wherein the polyolefin has an exo-olefin end-group content of at least 95%.

38. The method of claim 27, wherein the unsaturated acidic reactant is of the formula: 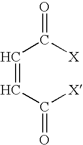
wherein X and X′ are each independently selected from the group consisting of —OH, —Cl, —O-lower alkyl, and when taken together, X and X′ are —O—.

39. The method of claim 38, wherein the acidic reactant comprises maleic anhydride.

40. The method of claim 27, wherein the polyolefin comprises a high molecular weight alkylvinylidene polyolefin having at least one branch per 2 carbon atoms along the chain.

41. The method of claim 29, wherein the cationically polymerizable monomer comprises isobutylene.
